(19) United States
(12) Patent Application Publication
(10) Pub. No.: US 2024/0107516 A1
(43) Pub. Date: Mar. 28, 2024

(54) FULL-DUPLEX ELIGIBILITY OR PRIORITIZATION

(71) Applicant: QUALCOMM Incorporated, San Diego, CA (US)

(72) Inventors: Yan ZHOU, San Diego, CA (US); Qian ZHANG, Basking Ridge, NJ (US); Tao LUO, San Diego, CA (US)

(21) Appl. No.: 17/934,728

(22) Filed: Sep. 23, 2022

(51) Int. Cl. H04W 72/12; H04L 5/00; H04L 5/14

(52) U.S. Cl. CPC H04W 72/1263; H04L 5/0051; H04L 5/14; H04W 72/1242

(57) ABSTRACT

Various aspects of the present disclosure generally relate to wireless communication. In some aspects, a network node may identify whether a first downlink channel or reference signal is permitted to overlap in time, in the full-duplex configuration, with a second uplink channel or reference signal based at least in part on: a first channel type or reference signal type of the first downlink channel or reference signal, or a second channel type or reference signal type of the second uplink channel or reference signal. The network node may schedule a communication of a user equipment based at least in part on whether the first downlink channel or reference signal is permitted to overlap in time, in the full-duplex configuration, with the second uplink channel or reference signal. Numerous other aspects are described.

### FIELD OF THE DISCLOSURE

Aspects of the present disclosure generally relate to wireless communication and to techniques and apparatuses for full-duplex eligibility or prioritization.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a network node for wireless communication. The network node may include a memory and one or more processors coupled to the memory. The one or more processors may be configured to identify whether a first downlink channel or reference signal is permitted to overlap in time, in a full-duplex configuration, with a second uplink channel or reference signal based at least in part on a first channel type or reference signal type of the first downlink channel or reference signal, or a second channel type or reference signal type of the second uplink channel or reference signal. The one or more processors may be configured to schedule a communication of a UE based at least in part on whether the first downlink channel or reference signal is permitted to overlap in time, in the full-duplex configuration, with the second uplink channel or reference signal.

Some aspects described herein relate to a network node for wireless communication. The network node may include a memory and one or more processors coupled to the memory. The one or more processors may be configured to output an indication of a resource type of a resource. The one or more processors may be configured to output a resource configuration for an uplink or downlink communication on the resource, wherein the resource configuration has a first link direction and the resource type of the resource indicates one of a resource type for a second link direction different than the first link direction, or a flexible resource type. The one or more processors may be configured to perform a communication with a UE in accordance with a prioritization rule indicating whether the first link direction or the second link direction is to be used for the resource.

Some aspects described herein relate to a UE for wireless communication. The user equipment may include a memory and one or more processors coupled to the memory. The one or more processors may be configured to identify whether a first downlink channel or reference signal is permitted to overlap in time, in a full-duplex configuration, with a second uplink channel or reference signal based at least in part on a first channel type or reference signal type of the first downlink channel or reference signal, or a second channel type or reference signal type of the second uplink channel or reference signal. The one or more processors may be configured to perform a communication with a network node based at least in part on whether the first downlink channel or reference signal is permitted to overlap in time, in the full-duplex configuration, with the second uplink channel or reference signal.

Some aspects described herein relate to a UE for wireless communication. The UE may include a memory and one or more processors coupled to the memory. The one or more processors may be configured to receive an indication of a resource type of a resource. The one or more processors may be configured to receive a resource configuration for an uplink or downlink communication on the resource, wherein the resource configuration has a first link direction and the resource type of the resource indicates one of a resource type for a second link direction different than the first link direction, or a flexible resource type. The one or more processors may be configured to perform a communication with a network node in accordance with a prioritization rule indicating whether the first link direction or the second link direction is to be used for the resource.

Some aspects described herein relate to a non-transitory computer-readable medium that stores a set of instructions for wireless communication by a network node. The set of instructions, when executed by one or more processors of the network node, may cause the network node to identify whether a first downlink channel or reference signal is permitted to overlap in time, in a full-duplex configuration, with a second uplink channel or reference signal based at least in part on a first channel type or reference signal type of the first downlink channel or reference signal, or a second channel type or reference signal type of the second uplink channel or reference signal. The set of instructions, when executed by one or more processors of the network node, may cause the network node to schedule a communication of a UE based at least in part on whether the first downlink channel or reference signal is permitted to overlap in time, in the full-duplex configuration, with the second uplink channel or reference signal.

Some aspects described herein relate to a non-transitory computer-readable medium that stores a set of instructions for wireless communication by a network node. The set of instructions, when executed by one or more processors of the network node, may cause the network node to output an indication of a resource type of a resource. The set of instructions, when executed by one or more processors of the network node, may cause the network node to output a resource configuration for an uplink or downlink communication on the resource, wherein the resource configuration has a first link direction and the resource type of the resource indicates one of a resource type for a second link direction different than the first link direction, or a flexible resource type. The set of instructions, when executed by one or more processors of the network node, may cause the network node to perform a communication with a UE in accordance with a prioritization rule indicating whether the first link direction or the second link direction is to be used for the resource.

Some aspects described herein relate to a non-transitory computer-readable medium that stores a set of instructions for wireless communication by a UE. The set of instructions, when executed by one or more processors of the UE, may cause the UE to identify whether a first downlink channel or reference signal is permitted to overlap in time, in a full-duplex configuration, with a second uplink channel or reference signal based at least in part on a first channel type or reference signal type of the first downlink channel or reference signal, or a second channel type or reference signal type of the second uplink channel or reference signal. The set of instructions, when executed by one or more processors of the UE, may cause the UE to perform a communication with a network node based at least in part on whether the first downlink channel or reference signal is permitted to overlap in time, in the full-duplex configuration, with the second uplink channel or reference signal.

Some aspects described herein relate to a non-transitory computer-readable medium that stores a set of instructions for wireless communication by a one or more instructions that, when executed by one or more processors of an UE. The set of instructions, when executed by one or more processors of the one or more instructions that, when executed by one or more processors of an UE, may cause the one or more instructions that, when executed by one or more processors of an UE to receive an indication of a resource type of a resource. The set of instructions, when executed by one or more processors of the one or more instructions that, when executed by one or more processors of an UE, may cause the one or more instructions that, when executed by one or more processors of an UE to receive a resource configuration for an uplink or downlink communication on the resource, wherein the resource configuration has a first link direction and the resource type of the resource indicates one of a resource type for a second link direction different than the first link direction, or a flexible resource type. The set of instructions, when executed by one or more processors of the one or more instructions that, when executed by one or more processors of an UE, may cause the one or more instructions that, when executed by one or more processors of an UE to perform a communication with a network node in accordance with a prioritization rule indicating whether the first link direction or the second link direction is to be used for the resource.

Some aspects described herein relate to an apparatus for wireless communication. The apparatus may include means for identifying whether a first downlink channel or reference signal is permitted to overlap in time, in a full-duplex configuration, with a second uplink channel or reference signal based at least in part on, a first channel type or reference signal type of the first downlink channel or reference signal, or a second channel type or reference signal type of the second uplink channel or reference signal. The apparatus may include means for scheduling a communication of a UE based at least in part on whether the first downlink channel or reference signal is permitted to overlap in time, in the full-duplex configuration, with the second uplink channel or reference signal.

Some aspects described herein relate to an apparatus for wireless communication. The apparatus may include means for outputting an indication of a resource type of a resource. The apparatus may include means for outputting a resource configuration for an uplink or downlink communication on the resource, wherein the resource configuration has a first link direction and the resource type of the resource indicates one of a resource type for a second link direction different than the first link direction, or a flexible resource type. The apparatus may include means for performing a communication with a UE in accordance with a prioritization rule indicating whether the first link direction or the second link direction is to be used for the resource.

Some aspects described herein relate to an apparatus for wireless communication. The apparatus may include means for identifying whether a first downlink channel or reference signal is permitted to overlap in time, in a full-duplex configuration, with a second uplink channel or reference signal based at least in part on a first channel type or reference signal type of the first downlink channel or reference signal, or a second channel type or reference signal type of the second uplink channel or reference signal. The apparatus may include means for performing a communication with a network node based at least in part on whether the first downlink channel or reference signal is permitted to overlap in time, in the full-duplex configuration, with the second uplink channel or reference signal.

Some aspects described herein relate to an apparatus for wireless communication. The apparatus may include means for receiving an indication of a resource type of a resource. The apparatus may include means for receiving a resource configuration for an uplink or downlink communication on the resource, wherein the resource configuration has a first link direction and the resource type of the resource indicates one of a resource type for a second link direction different than the first link direction, or a flexible resource type. The apparatus may include means for performing a communication with a network node in accordance with a prioritization rule indicating whether the first link direction or the second link direction is to be used for the resource.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of full-duplex communication in a wireless network, in accordance with the present disclosure.

FIG. 5 is a diagram illustrating an example of sub-band full duplex schemes, in accordance with the present disclosure.

FIGS. 6A-6D are diagrams illustrating examples of full-duplex communication in accordance with the present disclosure.

FIG. 7 is a diagram illustrating an example of physical channels and reference signals in a wireless network, in accordance with the present disclosure.

FIG. 8 is a diagram illustrating an example of signaling associated with identification of whether a first downlink channel or reference signal is permitted to overlap in time, in a full-duplex configuration, with a second uplink channel or reference signal, in accordance with the present disclosure.

FIG. 9 is a diagram illustrating an example of signaling associated with a prioritization rule for overlapping full-duplex communications, in accordance with the present disclosure.

FIGS. 10-13 is a flowchart illustrating example processes for wireless communication, in accordance with the present disclosure.

FIGS. 14-15 are diagrams illustrating example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

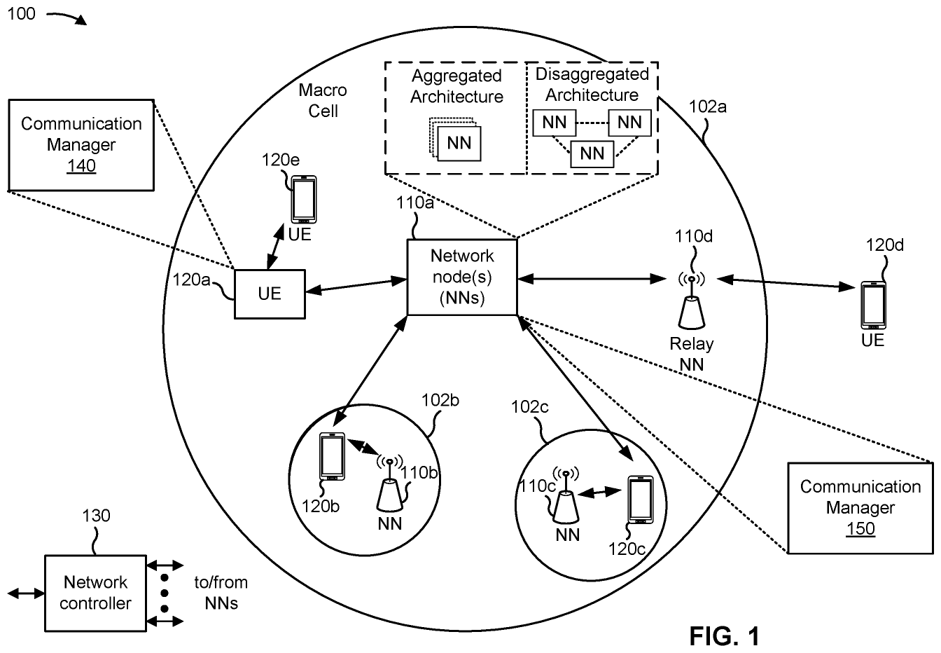

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the network node 110 may include a communication manager 150. As described in more detail elsewhere herein, the communication manager 150 may identify whether a first downlink channel or reference signal is permitted to overlap in time, in a full-duplex configuration, with a second uplink channel or reference signal based at least in part on: a first channel type or reference signal type of the first downlink channel or reference signal, or a second channel type or reference signal type of the second uplink channel or reference signal; and schedule a communication of a UE based at least in part on whether the first downlink channel or reference signal is permitted to overlap in time, in the full-duplex configuration, with the second uplink channel or reference signal. Additionally, or alternatively, the communication manager 150 may perform one or more other operations described herein.

In some aspects, the network node 110 may include a communication manager 150. As described in more detail elsewhere herein, the communication manager 150 may output an indication of a resource type of a resource; output a resource configuration for an uplink or downlink communication on the resource, wherein the resource configuration has a first link direction and the resource type of the resource indicates one of a resource type for a second link direction different than the first link direction, or a flexible resource type; and perform a communication with a UE in accordance with a prioritization rule indicating whether the first link direction or the second link direction is to be used for the resource. Additionally, or alternatively, the communication manager 150 may perform one or more other operations described herein.

In some aspects, the UE 120 may include a communication manager 140. As described in more detail elsewhere herein, the communication manager 140 may identify whether a first downlink channel or reference signal is permitted to overlap in time, in a full-duplex configuration, with a second uplink channel or reference signal based at least in part on: a first channel type or reference signal type of the first downlink channel or reference signal, or a second channel type or reference signal type of the second uplink channel or reference signal; and perform a communication with a network node based at least in part on whether the first downlink channel or reference signal is permitted to overlap in time, in the full-duplex configuration, with the second uplink channel or reference signal. Additionally, or alternatively, the communication manager 140 may perform one or more other operations described herein.

In some aspects, the UE 120 may include a communication manager 140. As described in more detail elsewhere herein, the communication manager 140 may receive an indication of a resource type of a resource; receive a resource configuration for an uplink or downlink communication on the resource, wherein the resource configuration has a first link direction and the resource type of the resource indicates one of a resource type for a second link direction different than the first link direction, or a flexible resource type; and perform a communication with a network node in accordance with a prioritization rule indicating whether the first link direction or the second link direction is to be used for the resource. Additionally, or alternatively, the communication manager 140 may perform one or more other operations described herein.

As indicated above, FIG. 1 is provided as an example. Other examples may differ from what is described with regard to FIG. 1.

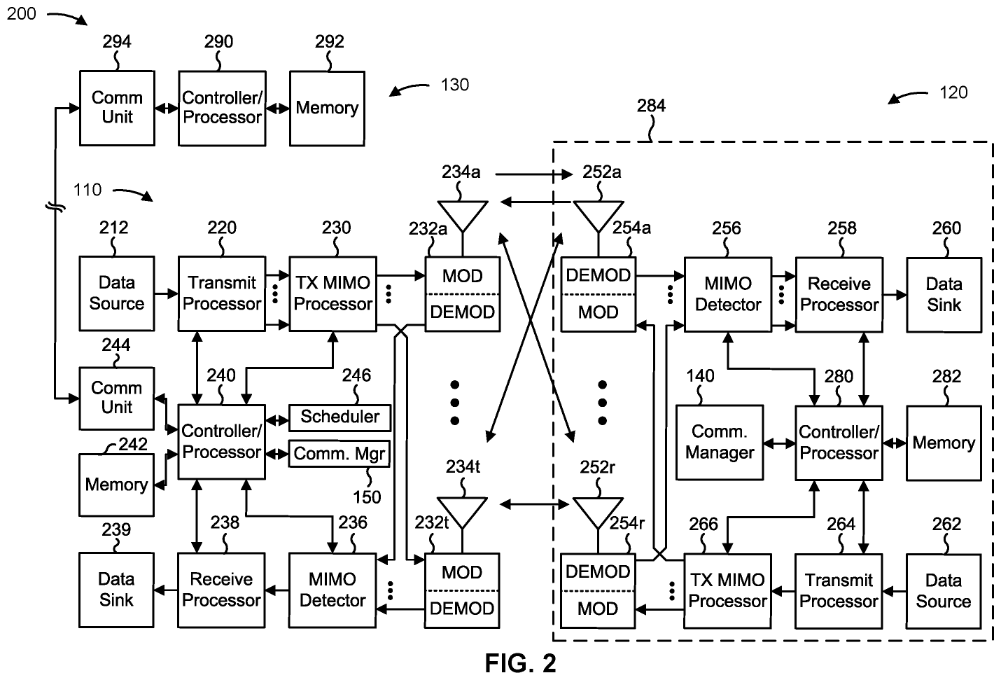

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

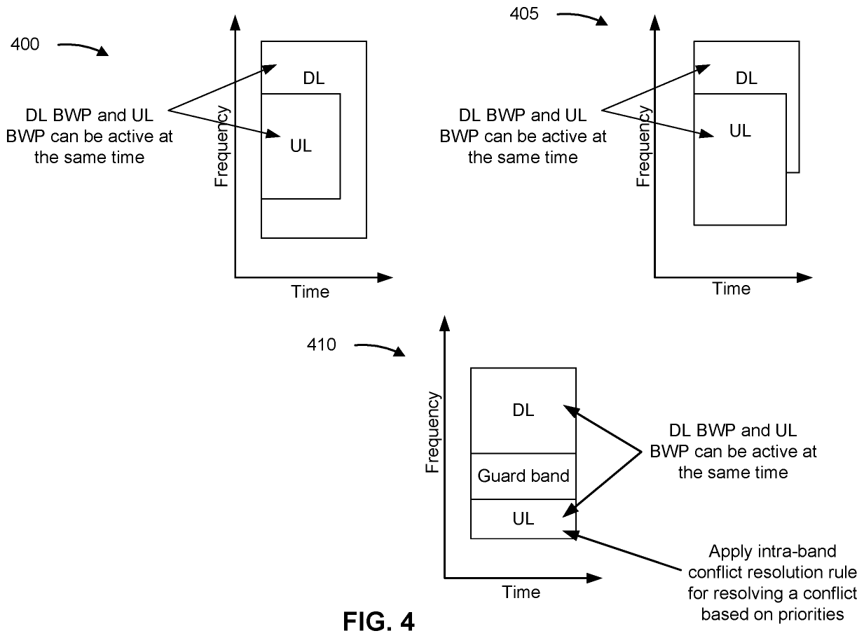

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-15).

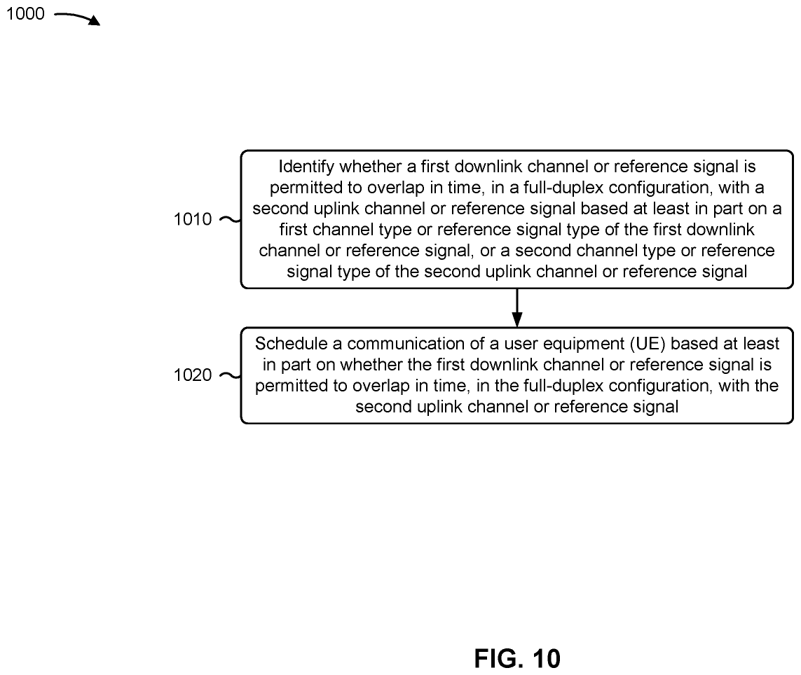

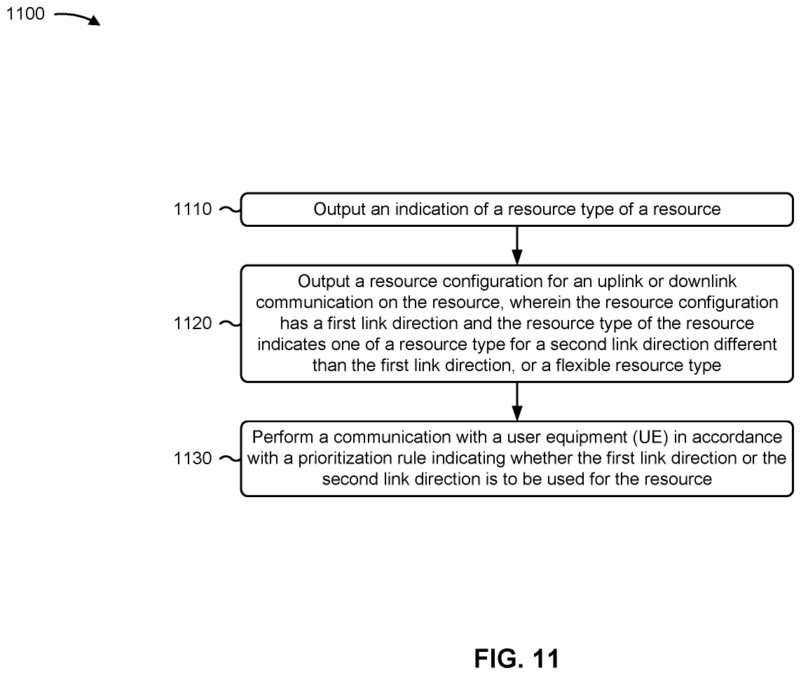

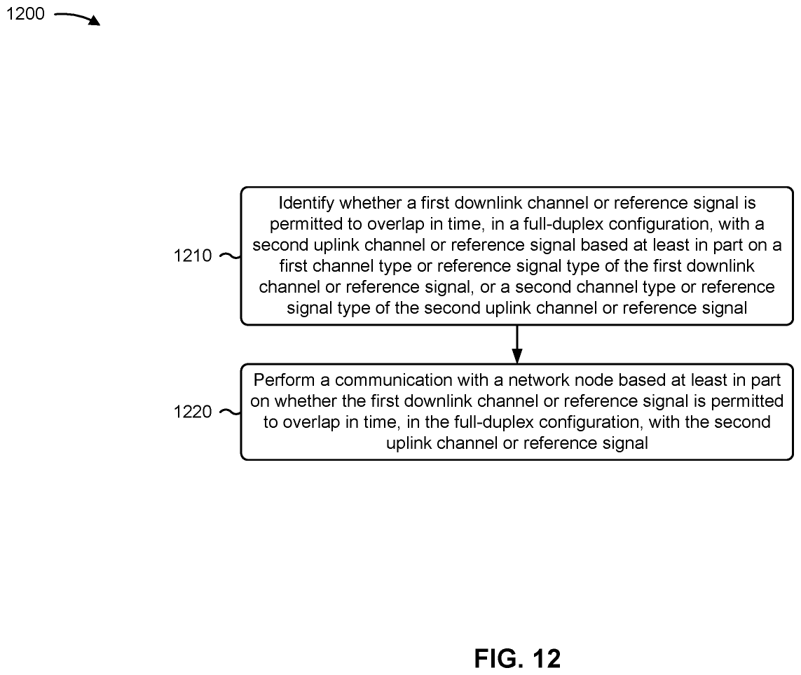

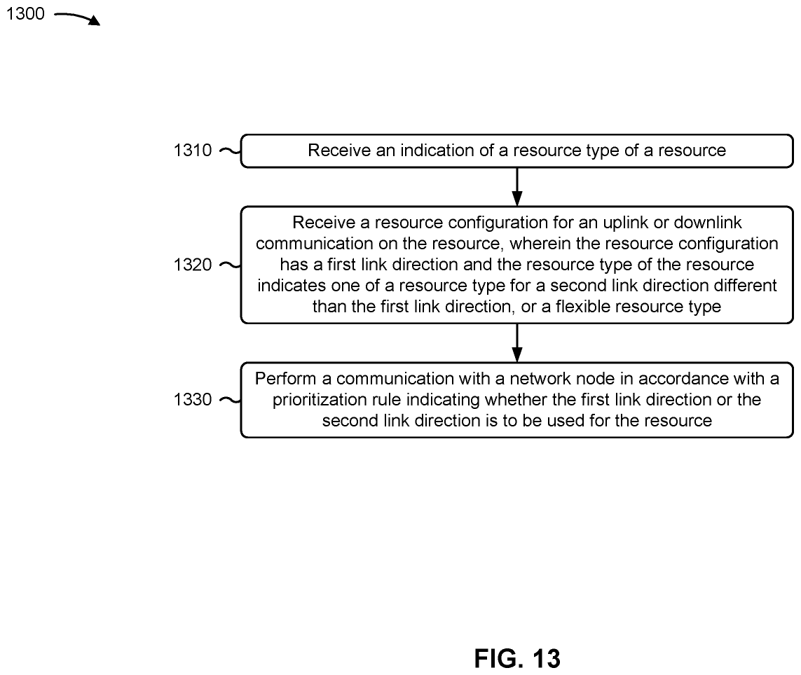

The controller/processor 240 of the network node 110, the controller/processor 280 of the UE 120, and/or any other component(s) of FIG. 2 may perform one or more techniques associated with full-duplex communication, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, process 1200 of FIG. 12, process 1300 of FIG. 13, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, the network node includes means for identifying whether a first downlink channel or reference signal is permitted to overlap in time, in a full-duplex configuration, with a second uplink channel or reference signal based at least in part on: a first channel type or reference signal type of the first downlink channel or reference signal, or a second channel type or reference signal type of the second uplink channel or reference signal; and/or means for scheduling a communication of a UE based at least in part on whether the first downlink channel or reference signal is permitted to overlap in time, in the full-duplex configuration, with the second uplink channel or reference signal. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the network node includes means for outputting an indication of a resource type of a resource; means for outputting a resource configuration for an uplink or downlink communication on the resource, wherein the resource configuration has a first link direction and the resource type of the resource indicates one of a resource type for a second link direction different than the first link direction, or a flexible resource type; and/or means for performing a communication with a UE in accordance with a prioritization rule indicating whether the first link direction or the second link direction is to be used for the resource. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the UE includes means for identifying whether a first downlink channel or reference signal is permitted to overlap in time, in a full-duplex configuration, with a second uplink channel or reference signal based at least in part on: a first channel type or reference signal type of the first downlink channel or reference signal, or a second channel type or reference signal type of the second uplink channel or reference signal; and/or means for performing a communication with a network node based at least in part on whether the first downlink channel or reference signal is permitted to overlap in time, in the full-duplex configuration, with the second uplink channel or reference signal. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for receiving an indication of a resource type of a resource; means for receiving a resource configuration for an uplink or downlink communication on the resource, wherein the resource configuration has a first link direction and the resource type of the resource indicates one of a resource type for a second link direction different than the first link direction, or a flexible resource type; and/or means for performing a communication with a network node in accordance with a prioritization rule indicating whether the first link direction or the second link direction is to be used for the resource. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282. While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

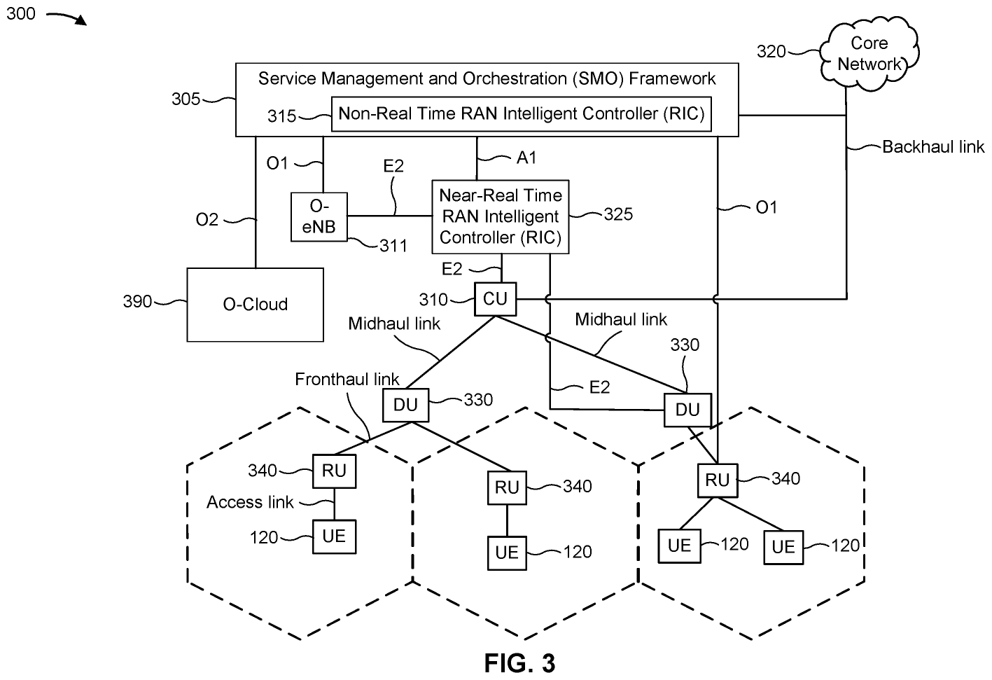

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT MC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating examples 400, 405, and 410 of full-duplex communication in a wireless network, in accordance with the present disclosure. “Full-duplex communication” in a wireless network refers to simultaneous bi-directional communication between devices in the wireless network. For example, a UE operating in a full-duplex mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol).

As shown in FIG. 4, examples 400 and 405 show examples of in-band full-duplex (IBFD) communication. In IBFD, a UE may transmit an uplink communication to a network node and receive a downlink communication from the network node on the same time and frequency resources. As shown in example 400, in a first example of IBFD, the time and frequency resources for uplink communication may fully overlap with the time and frequency resources for downlink communication. As shown in example 405, in a second example of IBFD, the time and frequency resources for uplink communication may partially overlap with the time and frequency resources for downlink communication.

As further shown in FIG. 4, example 410 shows an example of sub-band full-duplex (SBFD) communication, which may also be referred to as “sub-band frequency division duplex (SBFDD)” or “flexible duplex.” In SBFD, a UE may transmit an uplink communication to a network node and receive a downlink communication from the network node at the same time, but on different frequency resources. Alternatively, the network node may receive an uplink communication from a first UE on uplink frequency resources and may transmit a downlink communication to a second UE on downlink frequency resources. For example, the different frequency resources may be sub-bands of a frequency band, such as a time division duplexing band. In some examples, the frequency resources used for downlink communication may be separated from the frequency resources used for uplink communication, in the frequency domain, by a guard band.

In some examples, a conflict may arise between a first communication or resource of the SBFD scheme (on a first cell) and a second communication or resource, which may be associated with the SBFD scheme and may be on a second cell. Some techniques described herein provide intra-band conflict resolution according to an intra-band conflict resolution rule for resolving such a conflict based on relative priorities of the first communication or resource and the second communication or resource.

As indicated above, FIG. 4 is provided as an example. Other examples may differ from what is described with respect to FIG. 4.

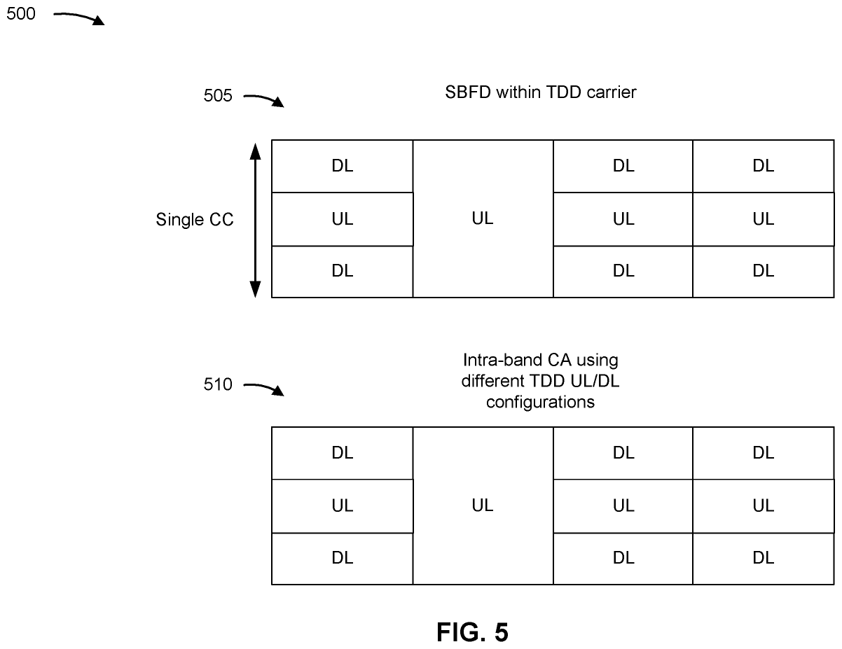

FIG. 5 is a diagram illustrating an example 500 of SBFD schemes, in accordance with the present disclosure. Example 500 illustrates a first SBFD scheme 505 and a second SBFD scheme 510. The first SBFD scheme 505 provides SBFD within a time division duplexing (TDD) carrier, in which a single CC's bandwidth is divided into non-overlapping UL and DL subbands. The second SBFD scheme 510 provides SBFD across multiple carriers (for example, intra-band carrier aggregation (CA)) using different TDD configurations. For example, CC1 and CC3 may have the same TDD configuration (e.g., DUDD, indicating a first slot is a DL slot, a second slot is a UL slot, and a third slot and a fourth slot are DL slots) and CC2 may be configured as an uplink carrier.

A TDD configuration may include a cell-common TDD configuration or a dedicated TDD configuration. A TDD configuration may be semi-statically configured via RRC signaling. A cell-common TDD configuration may be provided via an RRC parameter tdd-UL-DL-ConfigurationCommon, and may apply to all UEs associated with a cell. A dedicated TDD configuration may be provided via an RRC parameter tdd-UL-DL-ConfigurationDedicated and may apply to a UE to which the dedicated TDD configuration is directed. A resource can also be semi-statically configured as a flexible resource (e.g., having a flexible resource type), referred to herein as an RRC-F resource. After configuration as a semi-statically configured resource, a flexible resource (e.g., RRC-F), such as a symbol of a slot, can be subsequently indicated as an uplink resource (e.g., a resource having an uplink resource type), a downlink resource (e.g., a resource having a downlink resource type), or a flexible resource by a slot format indicator (SFI). An SFI includes an index into a table that identifies how each symbol number in a slot should be configured (e.g., as an uplink resource, a downlink resource, or a flexible resource). A flexible resource indicated by an SFI as an uplink resource (e.g., as having an uplink resource type) is referred to as an SFI-U resource. A flexible resource indicated by an SFI as a downlink resource (e.g., as having a downlink resource type) is referred to as an SFI-D resource. A flexible resource indicated by an SFI as a flexible resource is referred to as an SFI-F resource. An SFI-D resource (or more generally, a resource having a downlink resource type) may have a downlink link direction. An SFI-U resource (or more generally, a resource having an uplink resource type) may have an uplink link direction.

In some aspects, a resource may be configured for an uplink or downlink communication by a resource configuration. For example, the resource configuration may be provided via higher layer (e.g., RRC) signaling. In some examples, the resource configuration may configure a resource for downlink communication, such as to receive a PDSCH (e.g., via a semi-persistent scheduling (SPS) configuration), a physical downlink control channel (PDCCH) (e.g., in a control resource set (CORESET)), or a channel state information reference signal (CSI-RS). In some aspects, the resource configuration may configure a resource for uplink communication, such as to transmit a PUSCH (e.g., via a configured grant (CG)), a physical uplink control channel (PUCCH), a sounding reference signal (SRS), or a PRACH. A resource configured for downlink communication by a resource configuration may have a downlink link direction, and a resource configured for uplink communication by a resource configuration may have an uplink link direction.

A legacy rule (such as a rule of a wireless communication specification) may indicate how a resource with a given link direction, configured with a resource configuration for an uplink or downlink communication in the opposite link direction, should be handled. For example, a network node (e.g., network node 110), such as a network node associated with a first TRP and a second TRP, may configure a resource with a resource type. The network node may further configure a resource configuration on the resource with the resource type. In some examples, the resource has a slot format indicated by an SFI (such as SFI-D, SFI-U, or SFI-F). In some other examples, the first resource has a slot format that is not indicated by an SFI (such as an RRC-F symbol). Alternatively, in some examples, the resource may be configured for downlink or uplink communication via dynamic grant. Examples of the legacy rule are provided below.

For symbols with a slot format indicated by an SFI, a configured PUSCH, PUCCH, or PRACH transmission on SFI-D or SFI-F symbols may be cancelled (e.g., a network node may not expect to receive the configured PUSCH, PUCCH, or PRACH transmission, and the UE may not transmit the transmission). For symbols with a slot format indicated by an SFI, a configured CSI-RS, SPS, or control resource set (CORESET) reception, overlapping with an SFI-U or SFI-F symbol, may be cancelled. A DL or UL dynamic grant may be allowed on SFI-F symbols, such that the network node can dynamically indicate for the UE to transmit or receive a communication. A CORESET is a configured set of resources, mapped to a search space set, in which a UE monitors for control information such as a PDCCH.

For RRC-F symbols that do not have a slot format indicated by an SFI, a configured PUSCH, PUCCH, or PRACH transmission on RRC-F symbols may be cancelled unless a particular parameter (e.g., EnableConfiguredUL-r16) is configured. A configured CSI-RS or SPS reception on RRC-F symbols may be cancelled. DL or UL dynamic grants, and CORESET reception, may be allowed on RRC-F symbols.

The above-described legacy rules may be effective for a network node that cannot simultaneously receive and transmit communications (e.g., in FD). However, some network nodes (such as multi-TRP network nodes, among other examples) may support FD communication. If the above-described rules are applied at a network node supporting FD, then network resources may be inefficiently utilized. For example, a network node supporting FD communication may be capable of receiving both a transmission or reception on a resource associated with a resource configuration, and a transmission or reception in the opposite link direction on a resource associated with a slot format indicated by an SFI or an RRC configuration. Therefore, a prioritization rule that is configured on an assumption of half-duplex capabilities (such as the above-described rules) may lead to decreased throughput and decreased efficiency of resource usage.

Some techniques described herein provide configuration (in a full-duplex configuration such as SBFD, partial overlap FD, or fully overlapped FD) of a resource that is associated with a flexible slot format or a slot format with a second link direction, with a resource configuration indicating a channel or reference signal with a first link direction. Examples are provided below. Thus, a downlink reception opportunity and an uplink transmission opportunity can coexist on the same resource (e.g., symbol, slot). Some techniques described herein provide a priority rule indicating which link direction, of the first link direction or the second link direction, should be used for the resource (for example, based at least in part on a priority level of a communication on the resource). A network node may perform a communication with a UE in accordance with the prioritization rule. Thus, the UE and the network node can identify whether a communication such as an uplink transmission or a downlink transmission should be performed or cancelled in accordance with the prioritization rule, which enables the configuration and utilization of a resource with a slot format and a configured communication having opposite link directions. In this way, throughput is increased and efficiency of resource usage is increased.

As indicated above, FIG. 5 is provided as an example. Other examples may differ from what is described with regard to FIG. 5.

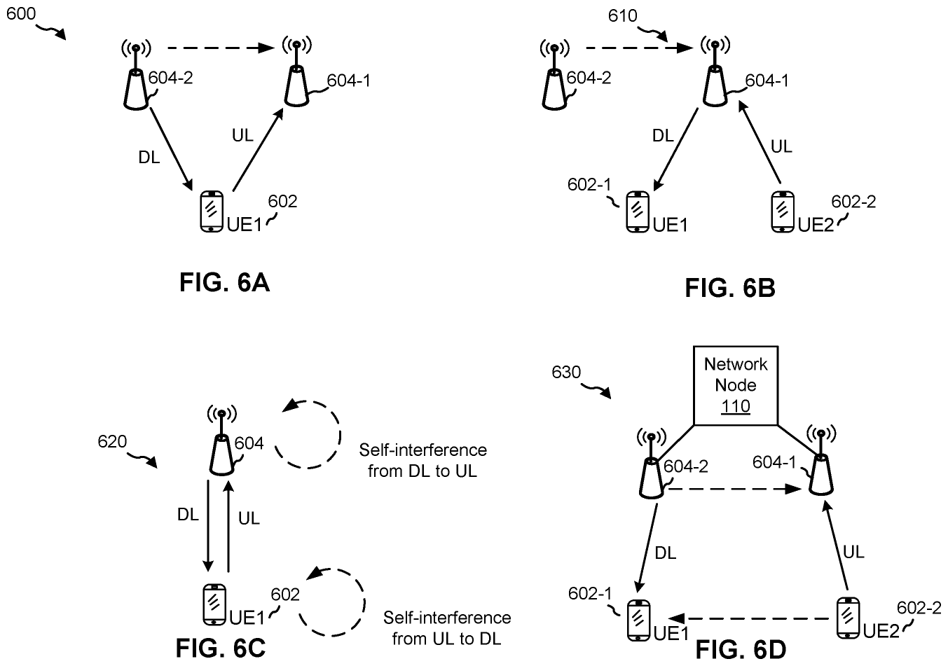

FIGS. 6A-6D are diagrams illustrating examples 600, 610, 620, 630 of FD communication in accordance with the present disclosure. An FD communication is a communication that utilizes overlapped time resources at a single node (such as a UE or a network node) for transmission and reception. For example, a UE or a network node may perform a transmission and a reception using the same time resources, such as via frequency division multiplexing (FDM) or spatial division multiplexing (SDM). “FDM” refers to performing two or more communications using different frequency resource allocations. “SDM” refers to performing two or more communications using different spatial parameters, such as different TCI states defining different beams. An SDM communication can use overlapped time resources and frequency resources, and an FDM communication can use overlapped time resources and spatial resources (that is, overlapped beam parameters, TCI states, or the like). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasi-co-location (QCL) type. A QCL type may indicate one or more spatial parameters to be derived from the source signal. The source signal may be referred to as a QCL source. FD communications can include dynamic traffic (such as scheduled by DCI) and/or semi-static traffic. Semi-static traffic is traffic associated with a semi-persistent resource, such as an SPS configured resource or a CG.

The example 600 of FIG. 6A includes a UE1 602 and two network nodes (e.g., TRPs) 604-1, 604-2, wherein the UE1 602 is sending uplink transmissions to the network node 604-1 and is receiving downlink transmissions from the network node 604-2. In some aspects, the network node 604 described in connection with FIGS. 6A-4D may be a base station, a TRP associated with (e.g., managed by) a network node, an RU, a DU, or a similar network node. In some aspects, the UEs 602 described in connection with FIGS. 6A-4D may be the UE 120 described in connection with FIGS. 1, 2, and 3, or a similar UE. In the example 600 of FIG. 6A, FD is enabled for the UE1 602, but not for the network nodes 604-1, 604-2. Thus, the network nodes 604-1 and 604-2 are half duplex (HD) network nodes.

The example 610 of FIG. 6B includes two UEs, UE1 602-1 and UE2 602-2, a network node 604-1, and a network node 604-2. The UE1 602-1 is receiving a downlink transmission from the network node 604-1 and the UE2 602-2 is transmitting an uplink transmission to the network node 604-1. In the example 610 of FIG. 6B, FD is enabled for the network node 604-1, but not for the UE1 602-1 and UE2 602-2. Thus, the UE1 602-1 and UE2 602-2 are half duplex UEs.

The example 620 of FIG. 6C includes a UE1 602 and a network node 604, wherein the UE1 602 is receiving a downlink transmission from the network node 604 and the UE1 602 is transmitting an uplink transmission to the network node 604. In the example 620 of FIG. 6C, FD is enabled for both the UE1 602 and the network node 604. In the example 620 of FIG. 6C, the UE1 602 and the network node 604 communicate using a beam pair. A beam pair may include a downlink beam and an uplink beam. For example, a UE1 602 may use a beam pair that includes a downlink beam (that is, a receive beam) at the UE1 602 and an uplink beam (that is, a transmit beam) at the UE1 602 to communicate with the network node 604. The network node 604 may use a downlink beam (that is, a transmit beam) at the network node 604 to transmit communications received via the UE1 602's downlink beam, and may use an uplink beam (that is, a receive beam) at the network node 604 to receive communications transmitted via the UE1 602's uplink beam.

The example 630 of FIG. 6D includes a network node 110 and two network nodes 604-1 and 604-2 associated with a cell (such as, e.g., a cell 102 described in connection with FIG. 1). The network nodes 604-1 and 604-2 may be either co-located (e.g., located at the same device, such as at the network node 110 or other device), or may be non-co-located (e.g., located apart from one another and/or from the network node 110, and thus may be standalone devices).

In FIGS. 6A-6D, interference is indicated by dashed lines. Interference can occur between network nodes of examples 600, 610, 620, 630 (referred to as cross-link interference (CLI)). In FIG. 6A, network node 604-2's downlink transmission interferes with network node 604-1's uplink transmission. In FIG. 6B, network node 604-1's uplink reception may be subject to interference from a transmission by a network node 604-2. CLI between network nodes 604 is referred to herein as inter-network node CLI. In some examples in FIG. 6B, UE2 602-2's uplink transmission may interfere with UE1 602-1's downlink transmission (not shown). Similarly, in FIG. 6D, UE2 602-2's uplink transmission interferes with UE1 602-1's downlink transmission. In some cases, self-interference can occur. Self-interference occurs when a node's transmission interferes with a reception operation of the node. For example, self-interference may occur due to reception by a receive antenna of radiated energy from a transmit antenna, cross-talk between components, or the like. Examples of self-interference at a UE 602 (from an uplink transmission to a downlink reception) and at a network node 604 (from a downlink transmission to an uplink reception) are shown in FIG. 6C. It should be noted that the above-described CLI and self-interference conditions can occur in HD deployments and in FD deployments.

Some network nodes support sub-band full duplex (SBFD) communication, as described below. SBFD communication may involve FD communication at a network node and HD communication at UEs, as shown, for example, in FIG. 6B.

As indicated above, FIGS. 6A-6D are provided as examples. Other examples may differ from what is described with regard to FIGS. 6A-6D.

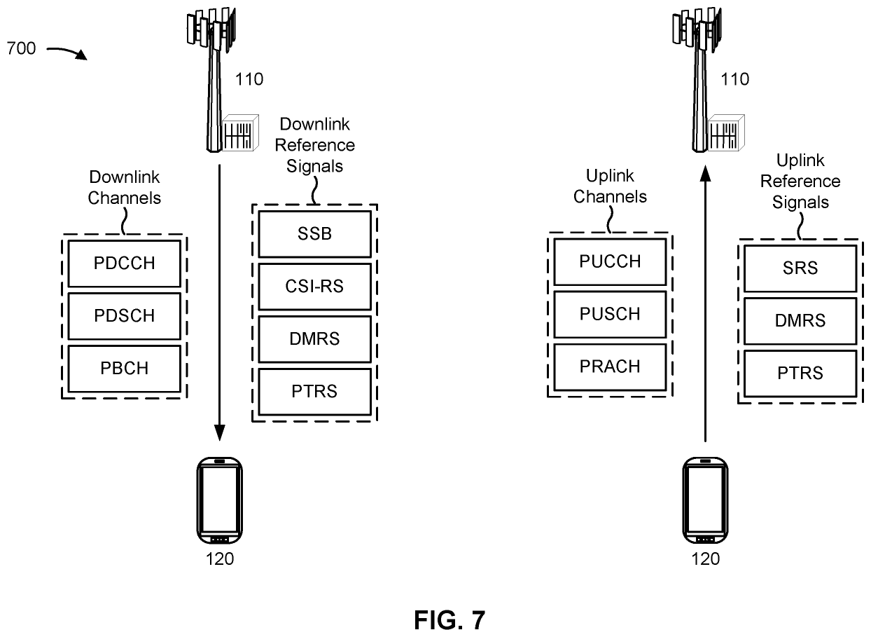

FIG. 7 is a diagram illustrating an example 700 of physical channels and reference signals in a wireless network, in accordance with the present disclosure. As shown in FIG. 7, downlink channels and downlink reference signals may carry information from a network node 110 to a UE 120, and uplink channels and uplink reference signals may carry information from a UE 120 to a network node 110.

As shown, a downlink channel may include a PDCCH that carries DCI, a PDSCH that carries downlink data, or a PBCH that carries system information, among other examples. In some aspects, PDSCH communications may be scheduled by PDCCH communications. As further shown, an uplink channel may include a PUCCH that carries UCI, a PUSCH that carries uplink data, or a PRACH used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, beam management, channel state feedback, tracking reference signaling, beam failure detection, candidate beam selection, pathloss reference signaling, measurement of a Layer 1 measurement value such as a Layer 1 reference signal received power (L1-RSRP) or a Layer 1 signal-to-interference-plus-noise ratio (L1-SINR), or radio link monitoring, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network node 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples. A CSI-RS can be periodic (e.g., configured with a periodicity), aperiodic (e.g., triggered, transmitted on-demand, scheduled dynamically), or semi-persistent (e.g., configured and activated, then transmitted until deactivated).

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120. An SRS can be periodic (e.g., configured with a periodicity), aperiodic (e.g., triggered, transmitted on-demand, scheduled dynamically), or semi-persistent (e.g., configured and activated, then transmitted until deactivated).

A first downlink channel or reference signal (such as one or more of the downlink channels or signals described with regard to FIG. 7) may overlap with a second uplink channel or reference signal (such as one or more of the uplink channels or signals described with regard to FIG. 7) in an FD configuration (sometimes referred to as “FD”). For example, the first downlink channel or reference signal and the second downlink channel or signal may overlap at a network node (such as a network node operating in FD), a UE (such as a UE operating in FD), or both. However, there are pairs of overlapping channels or signals (including a first downlink channel or reference signal and a second uplink channel or reference signal) that may be incompatible for overlap, even at an FD node such as a network node or a UE. Furthermore, a channel or signal may be associated with a use case, as described elsewhere herein. While it may be acceptable for a first channel or signal to be overlapped in FD with a second channel or signal for some use cases, it may be unacceptable in other use cases (for example, due to interference being acceptable in some use cases and not other use cases, due to relative priorities of communications in one use case relative to another use case, or the like). Thus, a one-size-fits-all rule indicating whether any pair of downlink and uplink channels or signals can be scheduled or configured may be inappropriate in various circumstances, leading to degradation of network communications, failure to efficiently utilize FD spectrum, and increases in latency.

Some techniques described herein provide identification of whether a first downlink channel or reference signal is permitted to overlap in time, in a full-duplex configuration, with a second uplink channel or reference signal. A full-duplex configuration may include a sub-band full-duplex configuration, an in-band full-duplex configuration, a partially overlapped full-duplex configuration (in which two channels or signals partially overlap one another), a fully overlapped full-duplex configuration (in which two channels or signals completely overlap one another), or the like. For example, two signals or channels in a full-duplex configuration may overlap with each other in at least one of time or frequency (e.g., both time and frequency). The identification may be based at least in part on at least one of a channel type or signal type of the first downlink channel or reference signal or a channel type or signal type of the second uplink channel or reference signal. A network node may schedule a communication of a UE based at least in part on whether the first downlink channel or reference signal is permitted to overlap in time, in a full-duplex configuration, with the second uplink channel or reference signal. The UE or the network node may identify whether the first downlink channel or reference signal is permitted to overlap in time the second uplink channel or reference signal based at least in part on signaling from the UE, signaling from the network node, or a rule (e.g., in a wireless communication specification). In some aspects, the identification may be based at least in part on a use case. For example, the identification may be based at least in part on the channel types or signal types of the first downlink channel or reference signal and the second uplink channel or reference signal, and the use case. In this way, permissions regarding overlapping channels or signals can be configured on a per-pair basis (such as for different pairs of overlapped channels or signals) and/or per use case, which improves efficiency of utilization of FD spectrum and reduces latency, relative to avoiding overlap in pairs of channels or signals.

As indicated above, FIG. 7 is provided as an example. Other examples may differ from what is described with regard to FIG. 7.

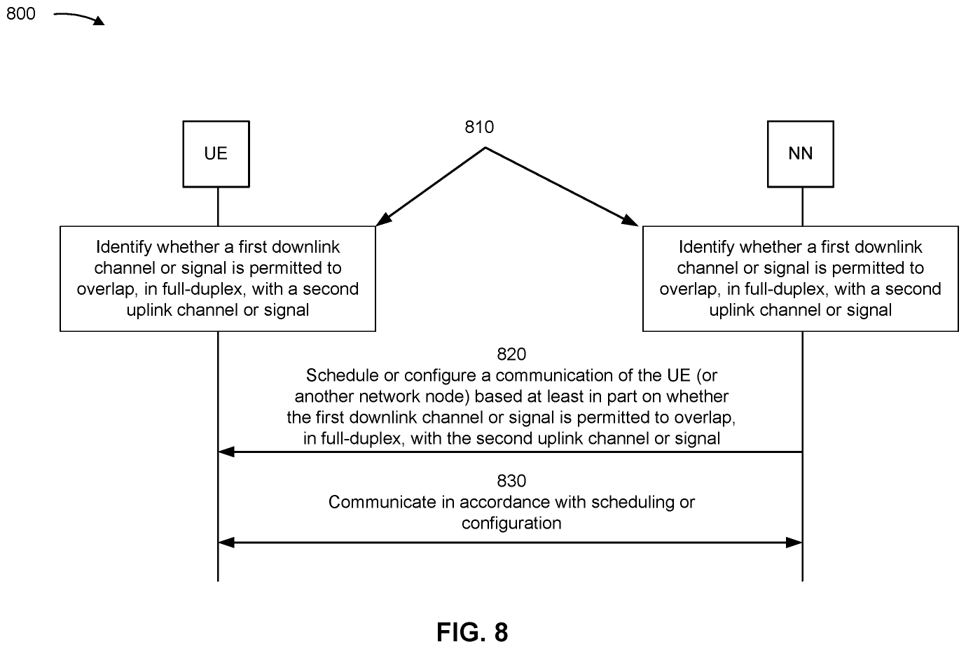

FIG. 8 is a diagram illustrating an example 800 of signaling associated with identification of whether a first downlink channel or reference signal is permitted to overlap in time, in a full-duplex configuration, with a second uplink channel or reference signal, in accordance with the present disclosure. Example 800 includes a UE (e.g., UE 120) and a network node (e.g., network node 110). In some aspects, the UE may be capable of FD communication. In some aspects, the network node may be capable of FD communication. In some aspects, both the UE and the network node may be capable of FD communication.

As shown by reference number 810, the UE and/or the network node may identify whether a first downlink channel or reference signal is permitted to overlap in time, in a full-duplex configuration, with a second uplink channel or reference signal. The UE and/or the network node may perform the identification based at least in part on a first channel type or reference signal type of the first downlink channel or reference signal, and/or based at least part on a second channel type or reference signal type of the second uplink channel or reference signal. For example, the first downlink channel or reference signal may have a first channel type or a first signal type. The second uplink channel or reference signal may have a second channel type or a second signal type. The UE and/or the network node may identify whether channels or signals of the first channel type or reference signal type are permitted to overlap in time with channels or signals of the second channel type or reference signal type, and may thereby identify whether the first downlink channel or reference signal is permitted to overlap in time with the second uplink channel or reference signal. The overlap can be at the UE (e.g., a first downlink channel or reference signal scheduled for reception at the UE may overlap with a second downlink channel or signal scheduled for transmission by the UE), the network node (e.g., a first downlink channel or reference signal scheduled for transmission by the network node may overlap with a second downlink channel or signal scheduled for reception by the network node), or both. For example, in some aspects, the first downlink channel or reference signal overlaps, in a full-duplex configuration, with the second uplink channel or reference signal at the network node based at least in part on the network node being a full-duplex network node. Additionally, or alternatively, in some aspects, the first downlink channel or reference signal overlaps, in a full-duplex configuration, with the second uplink channel or reference signal at the UE based at least in part on the UE being a full-duplex UE.

In some aspects, the UE may transmit signaling (e.g., capability information, uplink control information, or the like) indicating whether the first downlink channel or reference signal is permitted to overlap in time, in full duplex, with the second uplink channel or reference signal. In this example, the network node may identify whether a first downlink channel or reference signal is permitted to overlap in time, in a full-duplex configuration, with a second uplink channel or reference signal in accordance with the signaling received from the UE. For example, the UE may transmit signaling indicating whether a first (downlink) channel type is permitted to overlap in time with a second (uplink) channel type. As another example, the UE may transmit signaling indicating whether a first (downlink) channel type is permitted to overlap in time with a second (uplink) signal type. As another example, the UE may transmit signaling indicating whether a first (downlink) signal type is permitted to overlap in time with a second (uplink) channel type. As another example, the UE may transmit signaling indicating whether a first (downlink) signal type is permitted to overlap in time with a second (uplink) signal type. The signaling may be based at least in part on a capability of the UE, channel conditions at the UE, a hardware configuration of the UE, or the like.

In some aspects, the network node may transmit signaling (e.g., RRC signaling, system information, MAC signaling, DCI, or the like) indicating whether the first downlink channel or reference signal is permitted to overlap in time, in full duplex, with the second uplink channel or reference signal. In this example, the UE may identify whether a first downlink channel or reference signal is permitted to overlap in time, in a full-duplex configuration, with a second uplink channel or reference signal in accordance with the signaling received from the network node. For example, the network node may transmit signaling indicating whether a first (downlink) channel type is permitted to overlap in time with a second (uplink) channel type. As another example, the network node may transmit signaling indicating whether a first (downlink) channel type is permitted to overlap in time with a second (uplink) signal type. As another example, the network node may transmit signaling indicating whether a first (downlink) signal type is permitted to overlap in time with a second (uplink) channel type. As another example, the network node may transmit signaling indicating whether a first (downlink) signal type is permitted to overlap in time with a second (uplink) signal type. The signaling may be based at least in part on a capability of the UE, channel conditions at the UE, a hardware configuration of the UE, or the like.

In some aspects, the network node and the UE may identify whether a first downlink channel or reference signal is permitted to overlap in time, in a full-duplex configuration, with a second uplink channel or reference signal based at least in part on a preconfigured rule, such as a rule of a wireless communication specification. The preconfigured rule may identify a particular overlapped pair of one or more channel types and/or one or more signal types, and may indicate whether the particular overlapped pair is permitted. As another example, the preconfigured rule may indicate one or more first channel or signal types that are not permitted to overlap in time one or more second channel or signal types. As another example, the preconfigured rule may indicate one or more first channel or signal types that are permitted to overlap in time one or more second channel or signal types.

In some aspects, the UE and the network node may be associated with a beam pair. In some aspects, a beam pair may include a UE-side beam and a network-node-side beam. For example, the UE may use the UE-side beam for transmission and reception of FD communications to and from the network node. The network node may use the network-node-side beam for transmission and reception of FD communications to and from the UE. In some aspects, a beam pair may include a transmit beam and a receive beam at the UE, and a transmit beam and a receive beam at the network node.

In some aspects, identifying whether a first downlink channel or reference signal is permitted to overlap in time, in a full-duplex configuration, with a second uplink channel or reference signal is based at least in part on whether the first downlink channel or reference signal and the second uplink channel or reference signal are associated with a beam pair. For example, identifying whether the first downlink channel or reference signal is permitted to overlap in time, in a full-duplex configuration, with the second uplink channel or reference signal may be based at least in part on the first downlink channel or reference signal being associated with a beam pair. More particularly, whether the first downlink channel or reference signal is permitted to overlap in time, in a full-duplex configuration, with the second uplink channel or reference signal may depend on whether the first downlink channel or reference signal is to be transmitted using the same beam pair as the second uplink channel or reference signal. In some aspects, a first downlink channel or reference signal of a first channel type or reference signal type may be permitted to overlap in time a second uplink channel or reference signal of a second channel type or reference signal type when the first downlink channel or reference signal is not associated with a same beam pair as the second uplink channel or reference signal, and may not be permitted to overlap in time the second uplink channel or reference signal when the first downlink channel or reference signal and the second uplink channel or reference signal are associated with a same beam pair.

In some aspects, the first channel type or reference signal type is an SSB type. For example, a first downlink channel or reference signal having the SSB type may comprise an SSB. In some aspects, the first channel type or reference signal type is a PDCCH type. For example, a first downlink channel or reference signal having the PDCCH type may comprise a PDCCH. In some aspects, the first channel type or reference signal type is a PDSCH type. For example, a first downlink channel or reference signal having the PDSCH type may comprise a PDSCH. In some aspects, the first channel type or reference signal type is a CSI-RS type. For example, a first downlink channel or reference signal having the CSI-RS type may comprise a CSI-RS. In some aspects, the first channel type or reference signal type is a positioning reference signal (PRS) type. For example, a first downlink channel or reference signal having the PRS type may comprise a PRS. In some aspects, the PDSCH type may be a dynamic grant PDSCH type, which corresponds to a PDSCH granted by a dynamic grant. In some aspects, the PDSCH type may be a semi-persistent scheduling PDSCH type, which corresponds to a PDSCH granted by a semi-persistent scheduling configuration.

In some aspects, the CSI-RS type may be a periodic CSI-RS type, which is a CSI-RS associated with a periodic CSI-RS resource. In some aspects, the CSI-RS type may be an aperiodic CSI-RS type, which is a CSI-RS associated with an aperiodic CSI-RS resource, such as a triggered CSI-RS. In some aspects, the CSI-RS type may be a semi-persistent CSI-RS type, which is a CSI-RS associated with a semi-persistently scheduled CSI-RS resource. In some aspects, the CSI-RS type may be a channel state feedback (CSF) CSI-RS type, which is a CSI-RS used for the determination of CSF. In some aspects, the CSI-RS type may be a beam management CSI-RS type, which is a CSI-RS used for beam management. In some aspects, the CSI-RS type may be a tracking reference signal (TRS) CSI-RS type, which is a CSI-RS used for tracking (e.g., frequency tracking and/or time tracking). In some aspects, the CSI-RS type may be a radio resource management (RRM) CSI-RS type, which is a CSI-RS used for RRM operations. In some aspects, the CSI-RS type may be a beam failure detection (BFD) CSI-RS type, which is a CSI-RS used for BFD and/or beam failure recovery. In some aspects, the CSI-RS type may be a candidate beam detection CSI-RS type, which is a CSI-RS used for detection of a candidate beam at a UE. In some aspects, the CSI-RS type may be a pathloss reference signal CSI-RS type, which is a CSI-RS used to perform pathloss measurement. In some aspects, the CSI-RS type may be a Layer 1 measurement CSI-RS type, which is a CSI-RS used to perform a Layer 1 measurement such as an L1-RSRP or an L1-SINR. In some aspects, the CSI-RS type may be a radio link monitoring CSI-RS type, which is a CSI-RS used to perform radio link monitoring.

In some aspects, the second channel type or reference signal type is a PUCCH type. For example, a second uplink channel or reference signal having the PUCCH type may comprise a PUCCH. In some aspects, the second channel type or reference signal type is a PUSCH type. For example, a second uplink channel or reference signal having the PUSCH type may comprise a PUSCH. In some aspects, the second channel type or reference signal type is a PRACH type. For example, a second uplink channel or reference signal having the PRACH type may comprise a PRACH transmission. In some aspects, the second channel type or reference signal type is an SRS type. For example, a second uplink channel or reference signal having the SRS type may comprise an SRS. In some aspects, the second channel type or reference signal type is an uplink PRS type. For example, a second uplink channel or reference signal having the uplink PRS type may comprise an uplink PRS. In some aspects, the PUSCH type may be a dynamic grant PUSCH type, which corresponds to a PUSCH granted by a dynamic grant. In some aspects, the PUSCH type may be a configured grant PUSCH type, which corresponds to a PUSCH granted by a configured grant configuration. In some aspects, the PRACH type comprises a dynamically scheduled PRACH type, which is a PRACH scheduled by dynamic signaling. In some aspects, the PRACH type comprises a configured PRACH type, which is a PRACH on a configured resource (e.g., a contention-free PRACH).

In some aspects, the SRS type is a periodic SRS type, which is an SRS associated with a configured periodicity. In some aspects, the SRS type is an aperiodic SRS type, which is an SRS associated with an aperiodic SRS resource, such as a triggered SRS. In some aspects, the SRS type is a semi-persistent SRS type, which is an SRS associated with a semi-persistently scheduled SRS resource. In some aspects, the SRS type is a beam management SRS type, which is an SRS used for beam management. In some aspects, the SRS type is an antenna switching SRS type, which is an SRS used for antenna switching. In some aspects, the SRS type is a codebook-based uplink transmission SRS type, which is an SRS used for selection of a codebook for codebook-based uplink transmission. In some aspects, the SRS type is a non-codebook-based uplink transmission SRS type, which is an SRS used for selection of a precoder for non-codebook-based uplink transmission.

In some aspects, identifying whether a first downlink channel or reference signal is permitted to overlap in time, in a full-duplex configuration, with a second uplink channel or reference signal is based at least in part on a use case. For example, a first channel type or reference signal type may be permitted to overlap in time, in a full-duplex configuration, with a second channel type or reference signal type depending on the use case associated with the first channel type or reference signal type and/or the second channel type or reference signal type. The use case may be associated with the first downlink channel or reference signal, the second uplink channel or reference signal, or both. As used herein, “use case” refers to a scenario in which the first downlink channel or reference signal overlaps the second uplink channel or reference signal.

In some aspects, the use case may be an SBFD use case, in which at least one of the UE or the network node communicates using SBFD. In some aspects, the use case may be an SDM-based FD use case (such as a partial overlapping FD use case or a fully overlapping FD use case), in which at least one of the UE or the network node communicates using SDM-based FD. In some aspects, the use case may be an intra-operator use case, in which the first downlink channel or reference signal and the second uplink channel or reference signal are associated with a same operator. In some aspects, the use case may be an inter-operator use case (such as an inter-operator use case with shared spectrum or with adjacent spectrum), in which the first downlink channel or reference signal is associated with a first operator and the second downlink channel or signal is associated with a second operator. In some aspects, the use case may be a legacy UE use case, in which the UE (or another UE associated with the first downlink channel or reference signal or the second uplink channel or reference signal) is a legacy UE (e.g., a UE that does not support FD communication in accordance with a particular standard). In some aspects, the use case may be a full duplex aware UE use case, in which the UE is aware of or can process FD communications as FD communications (e.g., a UE that supports FD communication in accordance with a particular standard). In some aspects, the use case may be a use case associated with a particular frequency range (e.g., FR2 only, FR1 only), in which the first downlink channel or reference signal and the second uplink channel or reference signal are associated with a same frequency range. In some aspects, the use case may be associated with a particular band, in which the first downlink channel or reference signal and the second uplink channel or reference signal are associated with a same band. In some aspects, the use case may be associated with a particular band combination, in which the first downlink channel or reference signal is on a first band of the particular band combination and the second uplink channel or reference signal is on a second band of the particular band combination. In some aspects, the use case may be a full-duplex UE use case, in which the UE supports FD communication. In some aspects, the use case may be a full-duplex network node use case, in which the network node supports FD communication.

As shown by reference number 820, the network node may schedule or configure a communication of the UE (or another network node) based at least in part on whether the first downlink channel or reference signal is permitted to overlap in time, in a full-duplex configuration, with the second uplink channel or reference signal. For example, if the first downlink channel or reference signal is permitted to overlap in time the second uplink channel or reference signal in full-duplex, the network node may configure or schedule the first downlink channel or reference signal and the second uplink channel or reference signal in full-duplex. As another example, if the first downlink channel or reference signal is not permitted to overlap in time the second uplink channel or reference signal in full-duplex, the network node may configure the first downlink channel or reference signal such that the first downlink channel or reference signal does not overlap, in a full-duplex configuration, with the second uplink channel or reference signal. As shown by reference number 830, the UE and the network node may communicate in accordance with the scheduling or the configuration. For example, the network node may transmit, and the UE may receive, the first downlink channel or reference signal. As another example, the UE may transmit, and the network node may receive, the second uplink channel or reference signal.

As indicated above, FIG. 8 is provided as an example. Other examples may differ from what is described with regard to FIG. 8.

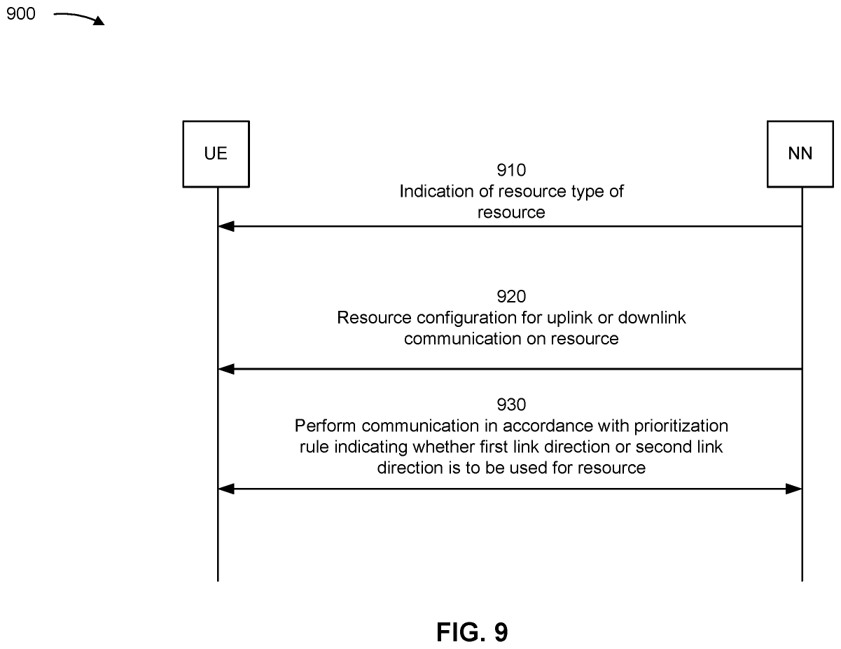

FIG. 9 is a diagram illustrating an example 900 of signaling associated with a prioritization rule for a resource with a resource type and a configured communication, in accordance with the present disclosure. Example 900 includes a UE (e.g., UE 120) and a network node (e.g., network node 110). In some aspects, the network node is capable of FD communication, such as using multiple TRPs. In some aspects, the UE is capable of FD communication. In some aspects, the network node and the UE are both capable of FD communication.

As shown by reference number 910, the network node may output an indication of a resource type of a resource. As shown by reference number 920, the network node may output a resource configuration for an uplink or downlink communication on the resource. The resource configuration may have a first link direction. The resource type may indicate a second link direction different than (e.g., the opposite of) the first link direction (e.g., SFI-D, SFI-U), or may indicate a flexible resource type (e.g., SFI-F, RRC-F). Thus, a downlink opportunity (such as a configuration or indication of a resource as having a downlink link direction or a flexible resource type) and a configured uplink opportunity, or a configured downlink opportunity and an uplink opportunity (such as a configuration or indication of a resource as having an uplink link direction or a flexible resource type), can coexist (e.g., may be allowed) on the same symbol. Thus, full-duplex configuration (e.g., SBFD, partially overlapped FD, fully overlapped FD, etc.) is facilitated on the resource.

In some aspects, the resource type of the resource is indicated by an SFI and is an uplink resource type or the flexible resource type (e.g., SFI-U or SFI-F), and the resource configuration is a configured CSI-RS configuration. For example, the network node may be permitted to configure a CSI-RS transmission on an SFI-U or SFI-F resource.

In some aspects, the resource type of the resource is indicated by an SFI and is an uplink resource type or the flexible resource type (e.g., SFI-U or SFI-F), and the resource configuration is a configured SPS configuration. For example, the network node may be permitted to configure an occasion of an SPS configuration on an SFI-U or SFI-F resource.

In some aspects, the resource type of the resource is indicated by an SFI and comprises a downlink resource type or the flexible resource type (e.g., SFI-D or SFI-F), and the resource configuration is a configured CORESET configuration. For example, the network node may be permitted to configure a CORESET (or a search space associated with a CORESET) on an SFI-D or SFI-F resource.

In some aspects, the resource type of the resource is indicated by an SFI and comprises a downlink resource type or the flexible resource type (e.g., SFI-D or SFI-F), and the resource configuration is a configured PUSCH configuration. For example, the network node may be permitted to configure a configured PUSCH transmission (e.g., a configured grant) on an SFI-D or SFI-F resource.

In some aspects, the resource type of the resource is indicated by an SFI and comprises a downlink resource type or the flexible resource type (e.g., SFI-D or SFI-F), and the resource configuration is a configured PUCCH configuration. For example, the network node may be permitted to configure a PUCCH transmission (e.g., a configured grant) on an SFI-D or SFI-F resource.

In some aspects, the resource type of the resource is indicated by an SFI and comprises a downlink resource type or the flexible resource type (e.g., SFI-D or SFI-F), and the resource configuration is a PRACH configuration. For example, the network node may be permitted to configure a PRACH transmission on an SFI-D or SFI-F resource.

In some aspects, the resource type is indicated by an RRC configuration and comprises the flexible resource type (e.g., RRC-F), and the resource configuration is a configured CSI-RS configuration. For example, the network node may be permitted to configure a CSI-RS transmission on an RRC-F resource.

In some aspects, the resource type is indicated by an RRC configuration and comprises the flexible resource type (e.g., RRC-F), and the resource configuration is a configured SPS configuration. For example, the network node may be permitted to configure an SPS occasion of an SPS configuration on an RRC-F resource.

In some aspects, the resource type is indicated by an RRC configuration and comprises the flexible resource type (e.g., RRC-F), and the resource configuration is a configured PUSCH configuration. For example, the network node may be permitted to configure a PUSCH transmission (e.g., a configured grant) on an RRC-F resource.

In some aspects, the resource type is indicated by an RRC configuration and comprises the flexible resource type (e.g., RRC-F), and the resource configuration is a configured PUCCH configuration. For example, the network node may be permitted to configure a PUCCH transmission on an RRC-F resource.

In some aspects, the resource type is indicated by an RRC configuration and comprises the flexible resource type (e.g., RRC-F), and the resource configuration is a PRACH configuration. For example, the network node may be permitted to configure a PRACH transmission (e.g., a PRACH resource) on an RRC-F resource.

As shown by reference number 930, the UE and the network node may perform a communication in accordance with a prioritization rule. The prioritization rule may indicate whether the first link direction (indicated by the resource configuration) or the second link direction (such as may be indicated by a resource type of the resource, if the resource type is SFI-D or SFI-U) is to be used for the resource. For example, the UE and the network node may determine whether to assume downlink communication or uplink communication on the resource according to the prioritization rule. In some aspects, the prioritization rule may indicate that a first communication, associated with a second link direction on the resource, is dropped if a second communication associated with a threshold priority on the resource is to be performed. For example, the resource may be associated with a flexible resource type or an SFI-D or SFI-U slot format. If the resource is associated with the SFI-D or SFI-U slot format, the first communication may have a link direction indicated by the SFI-D or SFI-U slot format. If the resource is associated with the RRC-F slot format or the SFI-F slot format, the first communication may have a link direction that is the opposite of the link direction of the second communication. In one example, the second communication is a scheduling request transmission. In another example, the second communication is a PRACH transmission for beam failure recovery. In some aspects, the threshold priority may be indicated by the second communication. In some aspects, the threshold priority may be based at least in part on a scenario associated with the second communication. For example, the scenario may include beam failure recovery, and the second communication may have the threshold priority based on the second communication being a communication for beam failure recovery (e.g., a scheduling request or physical random access channel).

In some aspects, the resource type is indicated by an SFI and is a downlink resource type or a flexible resource type (e.g., SFI-D or SFI-F), and performing the communication with the UE in accordance with the prioritization rule may include the UE transmitting, and the network node obtaining, an uplink transmission in the first link direction (e.g., uplink) based at least in part on the uplink transmission being associated with a threshold priority. For example, the uplink communication may include a scheduling request transmission or a PRACH transmission associated with a beam failure recovery. In this example, the UE may drop a downlink reception in the resource. If there is no uplink transmission associated with a threshold priority, the network node may output, and the UE may receive, a downlink transmission in the second link direction (e.g., downlink) on the resource. The downlink transmission may be configured by the resource configuration of reference number 820. For example, if beam failure recovery is not performed, the UE may receive a dynamic grant communication, a communication on an SPS occasion, or a CSI-RS.

In some aspects, the resource type is indicated by an RRC configuration and comprises the flexible resource type (e.g., RRC-F), and performing the communication with the UE in accordance with the prioritization rule further comprises the UE transmitting, and the network node obtaining, an uplink transmission in the first link direction (e.g., uplink) based at least in part on the uplink transmission being associated with a threshold priority. For example, the uplink communication may include a scheduling request transmission or a PRACH transmission associated with a beam failure recovery. In this example, the UE may drop a downlink reception in the resource. If there is no uplink transmission associated with a threshold priority, the network node may output, and the UE may receive, a downlink transmission in the second link direction (e.g., downlink) on the resource. The downlink transmission may be configured by the resource configuration of reference number 820. For example, if beam failure recovery is not performed, the UE may receive a dynamic grant communication, a communication on an SPS occasion, or a CSI-RS.

In some aspects, the resource type is indicated by an SFI and comprises an uplink resource type or the flexible resource type (SFI-U or SFI-F), and performing the communication in accordance with the prioritization rule further comprises the network node outputting, and the UE receiving, a downlink transmission in the first link direction (e.g., downlink) based at least in part on the downlink transmission being associated with a threshold priority. For example, the downlink transmission may include a downlink transmission associated with a high priority, such as a time-sensitive downlink communication or the like. In this example, the UE may drop an uplink transmission in the resource. If there is no downlink transmission associated with a threshold priority, the UE may transmit, and the network node may receive, an uplink transmission in the second link direction (e.g., uplink) on the resource. The uplink transmission may be configured by the resource configuration of reference number 920.

In some aspects, the resource type is indicated by an RRC configuration and comprises the flexible resource type (e.g., RRC-F), and performing the communication in accordance with the prioritization rule further comprises the network node outputting, and the UE receiving, a downlink transmission in the first link direction (e.g., downlink) based at least in part on the downlink transmission being associated with a threshold priority. For example, the downlink transmission may include a downlink transmission associated with a high priority, such as a time-sensitive downlink communication or the like. In this example, the UE may drop an uplink transmission in the resource. If there is no downlink transmission associated with a threshold priority, the UE may transmit, and the network node may receive, an uplink transmission in the second link direction (e.g., uplink) on the resource. The uplink transmission may be configured by the resource configuration of reference number 920.

As indicated above, FIG. 9 is provided as an example. Other examples may differ from what is described with regard to FIG. 9.

FIG. 10 is a diagram illustrating an example process 1000 performed, for example, by a network node, in accordance with the present disclosure. Example process 1000 is an example where the network node (e.g., network node 110) performs operations associated with full-duplex eligibility or prioritization.

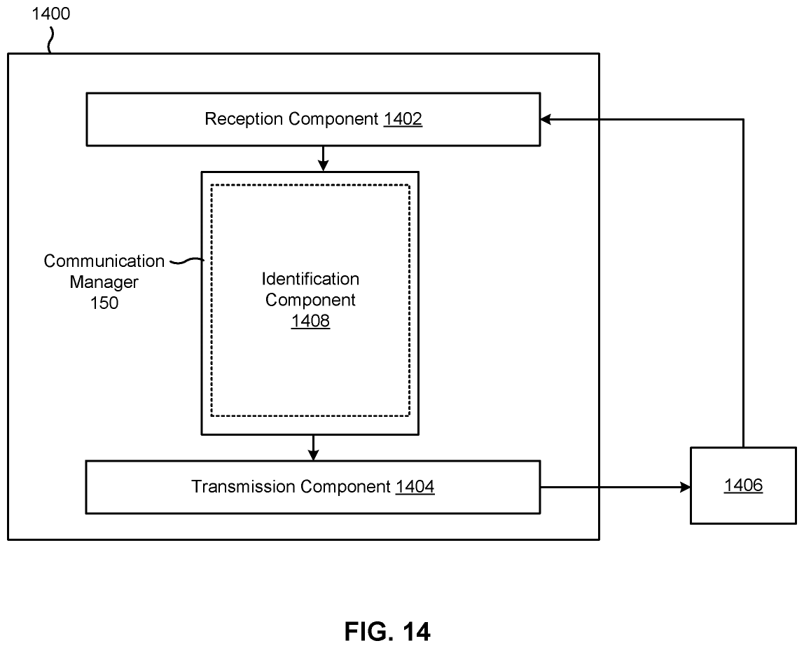

As shown in FIG. 10, in some aspects, process 1000 may include identifying whether a first downlink channel or reference signal is permitted to overlap in time, in a full-duplex configuration, with a second uplink channel or reference signal based at least in part on: a first channel type or reference signal type of the first downlink channel or reference signal, or a second channel type or reference signal type of the second uplink channel or reference signal (block 1010). For example, the network node (e.g., using communication manager 150 and/or identification component 1408, depicted in FIG. 14) may identify whether a first downlink channel or reference signal is permitted to overlap in time, in a full-duplex configuration, with a second uplink channel or reference signal based at least in part on: a first channel type or reference signal type of the first downlink channel or reference signal, or a second channel type or reference signal type of the second uplink channel or reference signal, as described above.

As further shown in FIG. 10, in some aspects, process 1000 may include scheduling a communication of a user equipment (UE) based at least in part on whether the first downlink channel or reference signal is permitted to overlap in time, in the full-duplex configuration, with the second uplink channel or reference signal (block 1020). For example, the network node (e.g., using communication manager 150 and/or transmission component 1404, depicted in FIG. 14) may schedule a communication of a user equipment (UE) based at least in part on whether the first downlink channel or reference signal is permitted to overlap in time, in the full-duplex configuration, with the second uplink channel or reference signal, as described above.

Process 1000 may include additional aspects, such as any single aspect or any combination of aspects described below and/or in connection with one or more other processes described elsewhere herein.

In a first aspect, identifying whether the first downlink channel or reference signal is permitted to overlap in time, in the full-duplex configuration, with the second uplink channel or reference signal further comprises receiving, from the UE, signaling indicating whether the first downlink channel or reference signal is permitted to overlap in time, in the full-duplex configuration, with the second uplink channel or reference signal.

In a second aspect, alone or in combination with the first aspect, identifying whether the first downlink channel or reference signal is permitted to overlap in time, in the full-duplex configuration, with the second uplink channel or reference signal is based at least in part on a preconfigured rule.

In a third aspect, alone or in combination with one or more of the first and second aspects, identifying whether the first downlink channel or reference signal is permitted to overlap in time, in the full-duplex configuration, with the second uplink channel or reference signal comprises identifying whether channels or signals of the first channel type or reference signal type are permitted to overlap in time with channels or signals of the second channel type or reference signal type.

In a fourth aspect, alone or in combination with one or more of the first through third aspects, identifying whether the first downlink channel or reference signal is permitted to overlap in time, in the full-duplex configuration, with the second uplink channel or reference signal is based at least in part on the first downlink channel or reference signal and the second uplink channel or reference signal being associated with a beam pair.

In a fifth aspect, alone or in combination with one or more of the first through fourth aspects, identifying whether the first downlink channel or reference signal is permitted to overlap in time, in the full-duplex configuration, with the second uplink channel or reference signal further comprises transmitting an indication of whether the first downlink channel or reference signal is permitted to overlap in time, in the full-duplex configuration, with the second uplink channel or reference signal.

In a sixth aspect, alone or in combination with one or more of the first through fifth aspects, the first downlink channel or reference signal overlaps, in the full-duplex configuration, with the second uplink channel or reference signal at the network node based at least in part on the network node being a full-duplex network node.

In a seventh aspect, alone or in combination with one or more of the first through sixth aspects, the first downlink channel or reference signal overlaps, in the full-duplex configuration, with the second uplink channel or reference signal at the UE based at least in part on the UE being a full-duplex UE.

In an eighth aspect, alone or in combination with one or more of the first through seventh aspects, the first channel type or reference signal type comprises at least one of a synchronization signal block (SSB) type, a physical downlink control channel (PDCCH) type, a physical downlink shared channel (PDSCH) type, a channel state information reference signal (CSI-RS) type, or a positioning reference signal (PRS) type.

In a ninth aspect, alone or in combination with one or more of the first through eighth aspects, the PDSCH type further comprises at least one of a dynamic grant PDSCH type or a semi-persistent scheduling PDSCH type.

In a tenth aspect, alone or in combination with one or more of the first through ninth aspects, the CSI-RS type further comprises at least one of a periodic CSI-RS type, an aperiodic CSI-RS type, a semi-persistent CSI-RS type, a channel state feedback CSI-RS type, a beam management CSI-RS type, a tracking reference signal CSI-RS type, a radio resource management CSI-RS type, a beam failure detection CSI-RS type, a candidate beam detection CSI-RS type, a pathloss reference signal CSI-RS type, a Layer 1 measurement CSI-RS type, or a radio link monitoring CSI-RS type.

In an eleventh aspect, alone or in combination with one or more of the first through tenth aspects, the second channel type or reference signal type comprises at least one of a physical uplink control channel (PUCCH) type, a physical uplink shared channel (PUSCH) type, a physical random access channel (PRACH) type, a sounding reference signal (SRS) type, or an uplink positioning reference signal (PRS) type.

In a twelfth aspect, alone or in combination with one or more of the first through eleventh aspects, the PUSCH type further comprises at least one of a dynamic grant PUSCH type or a configured grant PUSCH type.

In a thirteenth aspect, alone or in combination with one or more of the first through twelfth aspects, the PRACH type further comprises at least one of a dynamically scheduled PRACH type or a configured PRACH type.

In a fourteenth aspect, alone or in combination with one or more of the first through thirteenth aspects, the SRS type further comprises at least one of a periodic SRS type, an aperiodic SRS type, a semi-persistent SRS type, a beam management SRS type, an antenna switching SRS type, a codebook-based uplink transmission SRS type, or a non-codebook-based uplink transmission SRS type.

In a fifteenth aspect, alone or in combination with one or more of the first through fourteenth aspects, identifying whether the first downlink channel or reference signal is permitted to overlap in time, in the full-duplex configuration, with the second uplink channel or reference signal is based at least in part on a use case of the first downlink channel or reference signal or on a use case the second uplink channel or reference signal.

In a sixteenth aspect, alone or in combination with one or more of the first through fifteenth aspects, the use case of the first downlink channel or reference signal or the use case the second uplink channel or reference signal a subband full-duplex use case, a spatial-division-multiplexing-based partial overlapping or fully overlapping full-duplex use case, an intra-operator use case, an inter-operator use case, a legacy UE use case, a full duplex aware UE use case, a use case for a particular frequency range, band, or band combination, a full-duplex UE use case, or a full-duplex network node use case.

In a seventeenth aspect, alone or in combination with one or more of the first through sixteenth aspects, the full-duplex configuration comprises at least one of a sub-band full-duplex configuration, a partially overlapped full-duplex configuration, or a fully overlapped full-duplex configuration.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with full-duplex eligibility or prioritization.

As shown in FIG. 11, in some aspects, process 1100 may include outputting an indication of a resource type of a resource (block 1110). For example, the network node (e.g., using communication manager 150 and/or transmission component 1404, depicted in FIG. 14) may output an indication of a resource type of a resource, as described above.

As further shown in FIG. 11, in some aspects, process 1100 may include outputting a resource configuration for an uplink or downlink communication on the resource, wherein the resource configuration has a first link direction and the resource type of the resource indicates one of: a resource type for a second link direction different than the first link direction, or a flexible resource type (block 1120). For example, the network node (e.g., using communication manager 150 and/or configuration component 1408, depicted in FIG. 14) may output a resource configuration for an uplink or downlink communication on the resource, wherein the resource configuration has a first link direction and the resource type of the resource indicates one of: a resource type for a second link direction different than the first link direction, or a flexible resource type, as described above.

As further shown in FIG. 11, in some aspects, process 1100 may include performing a communication with a UE in accordance with a prioritization rule indicating whether the first link direction or the second link direction is to be used for the resource (block 1130). For example, the network node (e.g., using communication manager 150 and/or transmission component 1404, depicted in FIG. 14) may perform a communication with a user equipment (UE) in accordance with a prioritization rule indicating whether the first link direction or the second link direction is to be used for the resource, as described above.

Process 1100 may include additional aspects, such as any single aspect or any combination of aspects described below and/or in connection with one or more other processes described elsewhere herein.

In a first aspect, the resource type is indicated by a slot format indicator and comprises an uplink resource type or the flexible resource type, and the resource configuration is a configured channel state information reference signal configuration.

In a second aspect, alone or in combination with the first aspect, the resource type is indicated by a slot format indicator and comprises an uplink resource type or the flexible resource type, and the resource configuration is a configured semi-persistent scheduling configuration.

In a third aspect, alone or in combination with one or more of the first and second aspects, the resource type is indicated by a slot format indicator and comprises a downlink resource type or the flexible resource type, and the resource configuration is a configured control resource set configuration.

In a fourth aspect, alone or in combination with one or more of the first through third aspects, the resource type is indicated by a slot format indicator and comprises a downlink resource type or the flexible resource type, and the resource configuration is a configured physical uplink shared channel configuration.

In a fifth aspect, alone or in combination with one or more of the first through fourth aspects, the resource type is indicated by a slot format indicator and comprises a downlink resource type or the flexible resource type, and the resource configuration is a configured physical uplink control channel configuration.

In a sixth aspect, alone or in combination with one or more of the first through fifth aspects, the resource type is indicated by a slot format indicator and comprises a downlink resource type or the flexible resource type, and the resource configuration is a physical random access channel configuration.

In a seventh aspect, alone or in combination with one or more of the first through sixth aspects, the resource type is indicated by a radio resource control configuration and comprises the flexible resource type, and the resource configuration is a configured channel state information reference signal configuration.

In an eighth aspect, alone or in combination with one or more of the first through seventh aspects, the resource type is indicated by a radio resource control configuration and comprises the flexible resource type, and the resource configuration is a configured semi-persistent scheduling configuration.

In a ninth aspect, alone or in combination with one or more of the first through eighth aspects, the resource type is indicated by a radio resource control configuration and comprises the flexible resource type, and the resource configuration is a configured physical uplink shared channel configuration.

In a tenth aspect, alone or in combination with one or more of the first through ninth aspects, the resource type is indicated by a radio resource control configuration and comprises the flexible resource type, and the resource configuration is a configured physical uplink control channel configuration.

In an eleventh aspect, alone or in combination with one or more of the first through tenth aspects, the resource type is indicated by a radio resource control configuration and comprises the flexible resource type, and the resource configuration is a physical random access channel configuration.

In a twelfth aspect, alone or in combination with one or more of the first through eleventh aspects, the resource type is indicated by a slot format indicator and comprises a downlink resource type or the flexible resource type, wherein performing the communication with the UE in accordance with the prioritization rule further comprises obtaining an uplink transmission in the first link direction based at least in part on the uplink transmission being associated with a threshold priority.

In a thirteenth aspect, alone or in combination with one or more of the first through twelfth aspects, the resource type is indicated by a slot format indicator and comprises a downlink resource type or the flexible resource type, wherein performing the communication with the UE in accordance with the prioritization rule further comprises outputting a downlink transmission in the second link direction on the resource.

In a fourteenth aspect, alone or in combination with one or more of the first through thirteenth aspects, the resource type is indicated by a radio resource control configuration and comprises the flexible resource type, wherein performing the communication with the UE in accordance with the prioritization rule further comprises obtaining an uplink transmission in the first link direction based at least in part on the uplink transmission being associated with a threshold priority.

In a fifteenth aspect, alone or in combination with one or more of the first through fourteenth aspects, the resource type is indicated by a radio resource control configuration and comprises the flexible resource type, wherein performing the communication with the UE in accordance with the prioritization rule further comprises outputting a downlink transmission in the second link direction on the resource.

In a sixteenth aspect, alone or in combination with one or more of the first through fifteenth aspects, the resource type is indicated by a slot format indicator and comprises an uplink resource type or the flexible resource type, wherein performing the communication with the UE in accordance with the prioritization rule further comprises outputting a downlink transmission in the first link direction based at least in part on the downlink transmission being associated with a threshold priority.

In a seventeenth aspect, alone or in combination with one or more of the first through sixteenth aspects, the resource type is indicated by a slot format indicator and comprises a downlink resource type or the flexible resource type, wherein performing the communication with the UE in accordance with the prioritization rule further comprises obtaining an uplink transmission in the second link direction on the resource.

In an eighteenth aspect, alone or in combination with one or more of the first through seventeenth aspects, the resource type is indicated by a radio resource control configuration and comprises the flexible resource type, wherein performing the communication with the UE in accordance with the prioritization rule further comprises outputting a downlink transmission in the first link direction based at least in part on the downlink transmission being associated with a threshold priority.

In a nineteenth aspect, alone or in combination with one or more of the first through eighteenth aspects, the resource type is indicated by a radio resource control configuration and comprises the flexible resource type, wherein performing the communication with the UE in accordance with the prioritization rule further comprises obtaining an uplink transmission in the second link direction on the resource.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a user equipment (UE), in accordance with the present disclosure. Example process 1200 is an example where the UE (e.g., UE 120) performs operations associated with full-duplex eligibility or prioritization.

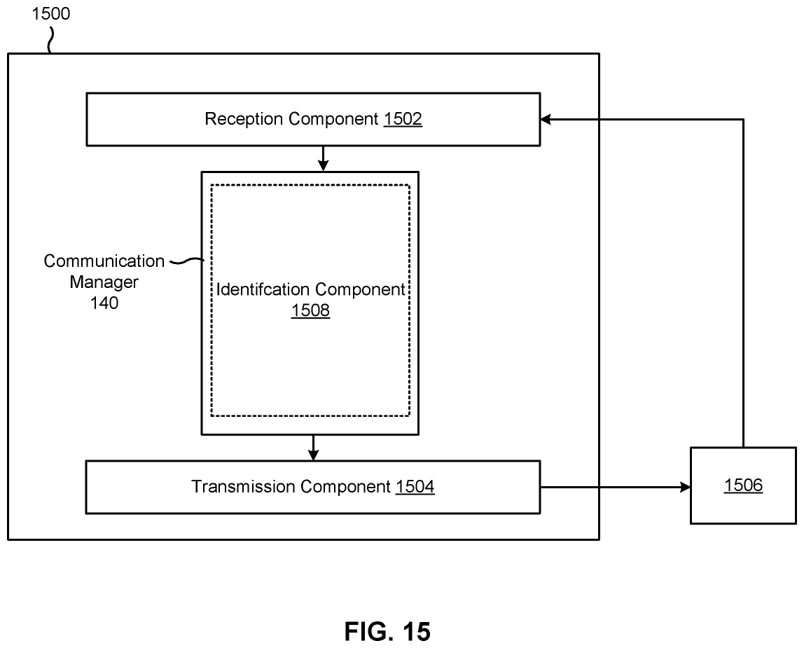

As shown in FIG. 12, in some aspects, process 1200 may include identifying whether a first downlink channel or reference signal is permitted to overlap in time, in a full-duplex configuration, with a second uplink channel or reference signal based at least in part on: a first channel type or reference signal type of the first downlink channel or reference signal, or a second channel type or reference signal type of the second uplink channel or reference signal (block 1210). For example, the UE (e.g., using communication manager 140 and/or identification component 1508, depicted in FIG. 15) may identify whether a first downlink channel or reference signal is permitted to overlap in time, in a full-duplex configuration, with a second uplink channel or reference signal based at least in part on: a first channel type or reference signal type of the first downlink channel or reference signal, or a second channel type or reference signal type of the second uplink channel or reference signal, as described above.

As further shown in FIG. 12, in some aspects, process 1200 may include performing a communication with a network node based at least in part on whether the first downlink channel or reference signal is permitted to overlap in time, in the full-duplex configuration, with the second uplink channel or reference signal (block 1220). For example, the UE (e.g., using communication manager 140 and/or reception component 1502, depicted in FIG. 15) may perform a communication with a network node based at least in part on whether the first downlink channel or reference signal is permitted to overlap in time, in the full-duplex configuration, with the second uplink channel or reference signal, as described above.

Process 1200 may include additional aspects, such as any single aspect or any combination of aspects described below and/or in connection with one or more other processes described elsewhere herein.

In a first aspect, identifying whether the first downlink channel or reference signal is permitted to overlap in time, in the full-duplex configuration, with the second uplink channel or reference signal further transmitting signaling indicating whether the first downlink channel or reference signal is permitted to overlap in time, in the full-duplex configuration, with the second uplink channel or reference signal.

In a second aspect, alone or in combination with the first aspect, identifying whether the first downlink channel or reference signal is permitted to overlap in time, in the full-duplex configuration, with the second uplink channel or reference signal is based at least in part on a preconfigured rule.

In a third aspect, alone or in combination with one or more of the first and second aspects, identifying whether the first downlink channel or reference signal is permitted to overlap in time, in the full-duplex configuration, with the second uplink channel or reference signal comprises identifying whether channels or signals of the first channel type or reference signal type are permitted to overlap in time with channels or signals of the second channel type or reference signal type.

In a fourth aspect, alone or in combination with one or more of the first through third aspects, identifying whether the first downlink channel or reference signal is permitted to overlap in time, in the full-duplex configuration, with the second uplink channel or reference signal is based at least in part on the first downlink channel or reference signal and the second uplink channel or reference signal being associated with a beam pair.

In a fifth aspect, alone or in combination with one or more of the first through fourth aspects, identifying whether the first downlink channel or reference signal is permitted to overlap in time, in the full-duplex configuration, with the second uplink channel or reference signal further comprises receiving an indication of whether the first downlink channel or reference signal is permitted to overlap in time, in the full-duplex configuration, with the second uplink channel or reference signal.

In a sixth aspect, alone or in combination with one or more of the first through fifth aspects, the first downlink channel or reference signal overlaps, in the full-duplex configuration, with the second uplink channel or reference signal at the network node based at least in part on the network node being a full-duplex network node.

In a seventh aspect, alone or in combination with one or more of the first through sixth aspects, the first downlink channel or reference signal overlaps, in the full-duplex configuration, with the second uplink channel or reference signal at the UE based at least in part on the UE being a full-duplex UE.

In an eighth aspect, alone or in combination with one or more of the first through seventh aspects, the first channel type or reference signal type comprises at least one of a synchronization signal block (SSB) type, a physical downlink control channel (PDCCH) type, a physical downlink shared channel (PDSCH) type, a channel state information reference signal (CSI-RS) type, or a positioning reference signal (PRS) type.

In a ninth aspect, alone or in combination with one or more of the first through eighth aspects, the PDSCH type further comprises at least one of a dynamic grant PDSCH type or a semi-persistent scheduling PDSCH type.

In a tenth aspect, alone or in combination with one or more of the first through ninth aspects, the CSI-RS type further comprises at least one of a periodic CSI-RS type, an aperiodic CSI-RS type, a semi-persistent CSI-RS type, a channel state feedback CSI-RS type, a beam management CSI-RS type, a tracking reference signal CSI-RS type, a radio resource management CSI-RS type, a beam failure detection CSI-RS type, a candidate beam detection CSI-RS type, a pathloss reference signal CSI-RS type, a Layer 1 measurement CSI-RS type, or a radio link monitoring CSI-RS type.

In an eleventh aspect, alone or in combination with one or more of the first through tenth aspects, the second channel type or reference signal type comprises at least one of a physical uplink control channel (PUCCH) type, a physical uplink shared channel (PUSCH) type, a physical random access channel (PRACH) type, a sounding reference signal (SRS) type, or an uplink positioning reference signal (PRS) type.

In a twelfth aspect, alone or in combination with one or more of the first through eleventh aspects, the PUSCH type further comprises at least one of a dynamic grant PUSCH type or a configured grant PUSCH type.

In a thirteenth aspect, alone or in combination with one or more of the first through twelfth aspects, the PRACH type further comprises at least one of a dynamically scheduled PRACH type or a configured PRACH type.

In a fourteenth aspect, alone or in combination with one or more of the first through thirteenth aspects, the SRS type further comprises at least one of a periodic SRS type, an aperiodic SRS type, a semi-persistent SRS type, a beam management SRS type, an antenna switching SRS type, a codebook-based uplink transmission SRS type, or a non-codebook-based uplink transmission SRS type.

In a fifteenth aspect, alone or in combination with one or more of the first through fourteenth aspects, identifying whether the first downlink channel or reference signal is permitted to overlap in time, in the full-duplex configuration, with the second uplink channel or reference signal is based at least in part on a use case of the first downlink channel or reference signal or on a use case the second uplink channel or reference signal.

In a sixteenth aspect, alone or in combination with one or more of the first through fifteenth aspects, the use case of the first downlink channel or reference signal or the use case the second uplink channel or reference signal a subband full-duplex use case, a spatial-division-multiplexing-based partial overlapping or fully overlapping full-duplex use case, an intra-operator use case, an inter-operator use case, a legacy UE use case, a full duplex aware UE use case, a use case for a particular frequency range, band, or band combination, a full-duplex UE use case, or a full-duplex network node use case.

In a seventeenth aspect, alone or in combination with one or more of the first through sixteenth aspects, the full-duplex configuration comprises at least one of a sub-band full-duplex configuration, a partially overlapped full-duplex configuration, or a fully overlapped full-duplex configuration.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by an UE, in accordance with the present disclosure. Example process 1300 is an example where the UE (e.g., UE 120) performs operations associated with full-duplex eligibility or prioritization.

As shown in FIG. 13, in some aspects, process 1300 may include receiving an indication of a resource type of a resource (block 1310). For example, the UE (e.g., using communication manager 140 and/or reception component 1502, depicted in FIG. 15) may receive an indication of a resource type of a resource, as described above.

As further shown in FIG. 13, in some aspects, process 1300 may include receiving a resource configuration for an uplink or downlink communication on the resource, wherein the resource configuration has a first link direction and the resource type of the resource indicates one of: a resource type for a second link direction different than the first link direction, or a flexible resource type (block 1320). For example, the UE (e.g., using communication manager 140 and/or reception component 1502, depicted in FIG. 15) may receive a resource configuration for an uplink or downlink communication on the resource, wherein the resource configuration has a first link direction and the resource type of the resource indicates one of: a resource type for a second link direction different than the first link direction, or a flexible resource type, as described above.

As further shown in FIG. 13, in some aspects, process 1300 may include performing a communication with a network node in accordance with a prioritization rule indicating whether the first link direction or the second link direction is to be used for the resource (block 1330). For example, the UE (e.g., using communication manager 140 and/or transmission component 1504, depicted in FIG. 15) may perform a communication with a network node in accordance with a prioritization rule indicating whether the first link direction or the second link direction is to be used for the resource, as described above.

Process 1300 may include additional aspects, such as any single aspect or any combination of aspects described below and/or in connection with one or more other processes described elsewhere herein.

In a first aspect, the resource type is indicated by a slot format indicator and comprises an uplink resource type or the flexible resource type, and the resource configuration is a configured channel state information reference signal configuration.

In a second aspect, alone or in combination with the first aspect, the resource type is indicated by a slot format indicator and comprises an uplink resource type or the flexible resource type, and the resource configuration is a configured semi-persistent scheduling configuration.

In a third aspect, alone or in combination with one or more of the first and second aspects, the resource type is indicated by a slot format indicator and comprises a downlink resource type or the flexible resource type, and the resource configuration is a configured control resource set configuration.

In a fourth aspect, alone or in combination with one or more of the first through third aspects, the resource type is indicated by a slot format indicator and comprises a downlink resource type or the flexible resource type, and the resource configuration is a configured physical uplink shared channel configuration.

In a fifth aspect, alone or in combination with one or more of the first through fourth aspects, the resource type is indicated by a slot format indicator and comprises an uplink resource type or the flexible resource type, and the resource configuration is a configured physical uplink control channel configuration.

In a sixth aspect, alone or in combination with one or more of the first through fifth aspects, the resource type is indicated by a slot format indicator and comprises an uplink resource type or the flexible resource type, and the resource configuration is a physical random access channel configuration.

In a seventh aspect, alone or in combination with one or more of the first through sixth aspects, the resource type is indicated by a radio resource control configuration and comprises the flexible resource type, and the resource configuration is a configured channel state information reference signal configuration.

In an eighth aspect, alone or in combination with one or more of the first through seventh aspects, the resource type is indicated by a radio resource control configuration and comprises the flexible resource type, and the resource configuration is a configured semi-persistent scheduling configuration.

In a ninth aspect, alone or in combination with one or more of the first through eighth aspects, the resource type is indicated by a radio resource control configuration and comprises the flexible resource type, and the resource configuration is a configured physical uplink shared channel configuration.

In a tenth aspect, alone or in combination with one or more of the first through ninth aspects, the resource type is indicated by a radio resource control configuration and comprises the flexible resource type, and the resource configuration is a configured physical uplink control channel configuration.

In an eleventh aspect, alone or in combination with one or more of the first through tenth aspects, the resource type is indicated by a radio resource control configuration and comprises the flexible resource type, and the resource configuration is a physical random access channel configuration.

In a twelfth aspect, alone or in combination with one or more of the first through eleventh aspects, the resource type is indicated by a slot format indicator and comprises a downlink resource type or the flexible resource type, wherein performing the communication in accordance with the prioritization rule further comprises transmitting an uplink transmission in the first link direction based at least in part on the uplink transmission being associated with a threshold priority, and dropping a downlink reception in the second link direction.

In a thirteenth aspect, alone or in combination with one or more of the first through twelfth aspects, the resource type is indicated by a slot format indicator and comprises a downlink resource type or the flexible resource type, wherein performing the communication in accordance with the prioritization rule further comprises receiving a downlink transmission in the second link direction on the resource.

In a fourteenth aspect, alone or in combination with one or more of the first through thirteenth aspects, the resource type is indicated by a radio resource control configuration and comprises the flexible resource type, wherein performing the communication in accordance with the prioritization rule further comprises transmitting an uplink transmission in the first link direction based at least in part on the uplink transmission being associated with a threshold priority, and dropping a downlink reception in the second link direction.

In a fifteenth aspect, alone or in combination with one or more of the first through fourteenth aspects, the resource type is indicated by a radio resource control configuration and comprises the flexible resource type, wherein performing the communication in accordance with the prioritization rule further comprises receiving a downlink transmission in the second link direction on the resource.

In a sixteenth aspect, alone or in combination with one or more of the first through fifteenth aspects, the resource type is indicated by a slot format indicator and comprises an uplink resource type or the flexible resource type, wherein performing the communication in accordance with the prioritization rule further comprises receiving a downlink transmission in the first link direction based at least in part on the downlink transmission being associated with a threshold priority, and dropping an uplink transmission in the second link direction.

In a seventeenth aspect, alone or in combination with one or more of the first through sixteenth aspects, the resource type is indicated by a slot format indicator and comprises a downlink resource type or the flexible resource type, wherein performing the communication in accordance with the prioritization rule further comprises transmitting an uplink transmission in the second link direction on the resource.

In an eighteenth aspect, alone or in combination with one or more of the first through seventeenth aspects, the resource type is indicated by a radio resource control configuration and comprises the flexible resource type, wherein performing the communication with the UE in accordance with the prioritization rule further comprises receiving a downlink transmission in the first link direction based at least in part on the downlink transmission being associated with a threshold priority, and dropping an uplink transmission in the second link direction.

In a nineteenth aspect, alone or in combination with one or more of the first through eighteenth aspects, the resource type is indicated by a radio resource control configuration and comprises the flexible resource type, wherein performing the communication with the UE in accordance with the prioritization rule further comprises transmitting an uplink transmission in the second link direction on the resource.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 150. The communication manager 150 may include one or more of an identification component 1408, among other examples.

In some aspects, the apparatus 1400 may be configured to perform one or more operations described herein in connection with FIGS. 4-9. Additionally, or alternatively, the apparatus 1400 may be configured to perform one or more processes described herein, such as process 1000 of FIG. 10, process 1100 of FIG. 11, or a combination thereof. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the network node described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the network node described in connection with FIG. 2. In some aspects, the transmission component 1404 may be co-located with the reception component 1402 in a transceiver.

The identification component 1408 may identify whether a first downlink channel or reference signal is permitted to overlap in time, in a full-duplex configuration, with a second uplink channel or reference signal based at least in part on a first channel type or reference signal type of the first downlink channel or reference signal, or a second channel type or reference signal type of the second uplink channel or reference signal. The transmission component 1404 may schedule a communication of a user equipment (UE) based at least in part on whether the first downlink channel or reference signal is permitted to overlap in time, in the full-duplex configuration, with the second uplink channel or reference signal.

The transmission component 1404 may output an indication of a resource type of a resource. The transmission component 14040 may output a resource configuration for an uplink or downlink communication on the resource, wherein the resource configuration has a first link direction and the resource type of the resource indicates one of a resource type for a second link direction different than the first link direction, or a flexible resource type. The reception component 1402 may perform a communication with a UE in accordance with a prioritization rule indicating whether the first link direction or the second link direction is to be used for the resource.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a UE, or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 140. The communication manager 140 may include one or more of an identification component 1508, among other examples.

In some aspects, the apparatus 1500 may be configured to perform one or more operations described herein in connection with FIGS. 4-9. Additionally, or alternatively, the apparatus 1500 may be configured to perform one or more processes described herein, such as process 1200 of FIG. 12, process 1300 of FIG. 13, or a combination thereof. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The identification component 1508 may identify whether a first downlink channel or reference signal is permitted to overlap in time, in a full-duplex configuration, with a second uplink channel or reference signal based at least in part on a first channel type or reference signal type of the first downlink channel or reference signal, or a second channel type or reference signal type of the second uplink channel or reference signal. The transmission component 1504 may perform a communication with a network node based at least in part on whether the first downlink channel or reference signal is permitted to overlap in time, in the full-duplex configuration, with the second uplink channel or reference signal.

The reception component 1502 may receive an indication of a resource type of a resource. The reception component 1502 may receive a resource configuration for an uplink or downlink communication on the resource, wherein the resource configuration has a first link direction and the resource type of the resource indicates one of a resource type for a second link direction different than the first link direction, or a flexible resource type. The transmission component 1504 may perform a communication with a network node in accordance with a prioritization rule indicating whether the first link direction or the second link direction is to be used for the resource.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a network node, comprising: identifying whether a first downlink channel or reference signal is permitted to overlap in time, in a full-duplex configuration, with a second uplink channel or reference signal based at least in part on: a first channel type or reference signal type of the first downlink channel or reference signal, or a second channel type or reference signal type of the second uplink channel or reference signal; and scheduling a communication of a user equipment (UE) based at least in part on whether the first downlink channel or reference signal is permitted to overlap in time, in the full-duplex configuration, with the second uplink channel or reference signal.

Aspect 2: The method of Aspect 1, wherein identifying whether the first downlink channel or reference signal is permitted to overlap in time, in the full-duplex configuration, with the second uplink channel or reference signal further comprises receiving, from the UE, signaling indicating whether the first downlink channel or reference signal is permitted to overlap in time, in the full-duplex configuration, with the second uplink channel or reference signal.

Aspect 3: The method of any of Aspects 1-2, wherein identifying whether the first downlink channel or reference signal is permitted to overlap in time, in the full-duplex configuration, with the second uplink channel or reference signal is based at least in part on a preconfigured rule.

Aspect 4: The method of any of Aspects 1-3, wherein identifying whether the first downlink channel or reference signal is permitted to overlap in time, in the full-duplex configuration, with the second uplink channel or reference signal comprises identifying whether channels or signals of the first channel type or reference signal type are permitted to overlap in time with channels or signals of the second channel type or reference signal type.

Aspect 5: The method of any of Aspects 1-4, wherein identifying whether the first downlink channel or reference signal is permitted to overlap in time, in the full-duplex configuration, with the second uplink channel or reference signal is based at least in part on the first downlink channel or reference signal and the second uplink channel or reference signal being associated with a beam pair.

Aspect 6: The method of any of Aspects 1-5, wherein identifying whether the first downlink channel or reference signal is permitted to overlap in time, in the full-duplex configuration, with the second uplink channel or reference signal further comprises transmitting an indication of whether the first downlink channel or reference signal is permitted to overlap in time, in the full-duplex configuration, with the second uplink channel or reference signal.

Aspect 7: The method of any of Aspects 1-6, wherein the first downlink channel or reference signal overlaps, in the full-duplex configuration, with the second uplink channel or reference signal at the network node based at least in part on the network node being a full-duplex network node.

Aspect 8: The method of any of Aspects 1-7, wherein the first downlink channel or reference signal overlaps, in the full-duplex configuration, with the second uplink channel or reference signal at the UE based at least in part on the UE being a full-duplex UE.

Aspect 9: The method of any of Aspects 1-8, wherein the first channel type or reference signal type comprises at least one of: a synchronization signal block (SSB) type, a physical downlink control channel (PDCCH) type, a physical downlink shared channel (PDSCH) type, a channel state information reference signal (CSI-RS) type, or a positioning reference signal (PRS) type.

Aspect 10: The method of Aspect 9, wherein the PDSCH type further comprises at least one of a dynamic grant PDSCH type or a semi-persistent scheduling PDSCH type.

Aspect 11: The method of Aspect 9, wherein the CSI-RS type further comprises at least one of: a periodic CSI-RS type, an aperiodic CSI-RS type, a semi-persistent CSI-RS type, a channel state feedback CSI-RS type, a beam management CSI-RS type, a tracking reference signal CSI-RS type, a radio resource management CSI-RS type, a beam failure detection CSI-RS type, a candidate beam detection CSI-RS type, a pathloss reference signal CSI-RS type, a Layer 1 measurement CSI-RS type, or a radio link monitoring CSI-RS type.

Aspect 12: The method of any of Aspects 1-11, wherein the second channel type or reference signal type comprises at least one of: a physical uplink control channel (PUCCH) type, a physical uplink shared channel (PUSCH) type, a physical random access channel (PRACH) type, a sounding reference signal (SRS) type, or an uplink positioning reference signal (PRS) type.

Aspect 13: The method of Aspect 12, wherein the PUSCH type further comprises at least one of a dynamic grant PUSCH type or a configured grant PUSCH type.

Aspect 14: The method of Aspect 12, wherein the PRACH type further comprises at least one of a dynamically scheduled PRACH type or a configured PRACH type.

Aspect 15: The method of Aspect 12, wherein the SRS type further comprises at least one of: a periodic SRS type, an aperiodic SRS type, a semi-persistent SRS type, a beam management SRS type, an antenna switching SRS type, a codebook-based uplink transmission SRS type, or a non-codebook-based uplink transmission SRS type.

Aspect 16: The method of any of Aspects 1-15, wherein identifying whether the first downlink channel or reference signal is permitted to overlap in time, in the full-duplex configuration, with the second uplink channel or reference signal is based at least in part on a use case of the first downlink channel or reference signal or on a use case the second uplink channel or reference signal.

Aspect 17: The method of Aspect 16, wherein the use case of the first downlink channel or reference signal or the use case the second uplink channel or reference signal: a subband full-duplex use case, a spatial-division-multiplexing-based partial overlapping or fully overlapping full-duplex use case, an intra-operator use case, an inter-operator use case, a legacy UE use case, a full duplex aware UE use case, a use case for a particular frequency range, band, or band combination, a full-duplex UE use case, or a full-duplex network node use case.

Aspect 18: The method of any of Aspects 1-17, wherein the full-duplex configuration comprises at least one of: a sub-band full-duplex configuration, a partially overlapped full-duplex configuration, or a fully overlapped full-duplex configuration.

Aspect 19: A method of wireless communication performed by a network node, comprising: outputting an indication of a resource type of a resource; outputting a resource configuration for an uplink or downlink communication on the resource, wherein the resource configuration has a first link direction and the resource type of the resource indicates one of: a resource type for a second link direction different than the first link direction, or a flexible resource type; and performing a communication with a user equipment (UE) in accordance with a prioritization rule indicating whether the first link direction or the second link direction is to be used for the resource.

Aspect 20: The method of Aspect 19, wherein the resource type is indicated by a slot format indicator and comprises an uplink resource type or the flexible resource type, and the resource configuration is a configured channel state information reference signal configuration.

Aspect 21: The method of any of Aspect 19, wherein the resource type is indicated by a slot format indicator and comprises an uplink resource type or the flexible resource type, and the resource configuration is a configured semi-persistent scheduling configuration.

Aspect 22: The method of Aspect 19, wherein the resource type is indicated by a slot format indicator and comprises a downlink resource type or the flexible resource type, and the resource configuration is a configured control resource set configuration.

Aspect 23: The method of Aspect 19, wherein the resource type is indicated by a slot format indicator and comprises a downlink resource type or the flexible resource type, and the resource configuration is a configured physical uplink shared channel configuration.

Aspect 24: The method of Aspect 19, wherein the resource type is indicated by a slot format indicator and comprises a downlink resource type or the flexible resource type, and the resource configuration is a configured physical uplink control channel configuration.

Aspect 25: The method of Aspect 19, wherein the resource type is indicated by a slot format indicator and comprises a downlink resource type or the flexible resource type, and the resource configuration is a physical random access channel configuration.

Aspect 26: The method of Aspect 19, wherein the resource type is indicated by a radio resource control configuration and comprises the flexible resource type, and the resource configuration is a configured channel state information reference signal configuration.

Aspect 27: The method of Aspect 19, wherein the resource type is indicated by a radio resource control configuration and comprises the flexible resource type, and the resource configuration is a configured semi-persistent scheduling configuration.

Aspect 28: The method of Aspect 19, wherein the resource type is indicated by a radio resource control configuration and comprises the flexible resource type, and the resource configuration is a configured physical uplink shared channel configuration.

Aspect 29: The method of Aspect 19, wherein the resource type is indicated by a radio resource control configuration and comprises the flexible resource type, and the resource configuration is a configured physical uplink control channel configuration.

Aspect 30: The method of Aspect 19, wherein the resource type is indicated by a radio resource control configuration and comprises the flexible resource type, and the resource configuration is a physical random access channel configuration.

Aspect 31: The method of Aspect 19, wherein the resource type is indicated by a slot format indicator and comprises a downlink resource type or the flexible resource type, wherein performing the communication with the UE in accordance with the prioritization rule further comprises: obtaining an uplink transmission in the first link direction based at least in part on the uplink transmission being associated with a threshold priority.

Aspect 32: The method of Aspect 19, wherein the resource type is indicated by a slot format indicator and comprises a downlink resource type or the flexible resource type, wherein performing the communication with the UE in accordance with the prioritization rule further comprises: outputting a downlink transmission in the second link direction on the resource.

Aspect 33: The method of Aspect 19, wherein the resource type is indicated by a radio resource control configuration and comprises the flexible resource type, wherein performing the communication with the UE in accordance with the prioritization rule further comprises: obtaining an uplink transmission in the first link direction based at least in part on the uplink transmission being associated with a threshold priority.

Aspect 34: The method of Aspect 19, wherein the resource type is indicated by a radio resource control configuration and comprises the flexible resource type, wherein performing the communication with the UE in accordance with the prioritization rule further comprises: outputting a downlink transmission in the second link direction on the resource.

Aspect 35: The method of Aspect 19, wherein the resource type is indicated by a slot format indicator and comprises an uplink resource type or the flexible resource type, wherein performing the communication with the UE in accordance with the prioritization rule further comprises: outputting a downlink transmission in the first link direction based at least in part on the downlink transmission being associated with a threshold priority.

Aspect 36: The method of Aspect 19, wherein the resource type is indicated by a slot format indicator and comprises a downlink resource type or the flexible resource type, wherein performing the communication with the UE in accordance with the prioritization rule further comprises: obtaining an uplink transmission in the second link direction on the resource.

Aspect 37: The method of Aspect 19, wherein the resource type is indicated by a radio resource control configuration and comprises the flexible resource type, wherein performing the communication with the UE in accordance with the prioritization rule further comprises: outputting a downlink transmission in the first link direction based at least in part on the downlink transmission being associated with a threshold priority.

Aspect 38: The method of Aspect 19, wherein the resource type is indicated by a radio resource control configuration and comprises the flexible resource type, wherein performing the communication with the UE in accordance with the prioritization rule further comprises: obtaining an uplink transmission in the second link direction on the resource.

Aspect 39: A method of wireless communication performed by a user equipment (UE), comprising: identifying whether a first downlink channel or reference signal is permitted to overlap in time, in a full-duplex configuration, with a second uplink channel or reference signal based at least in part on: a first channel type or reference signal type of the first downlink channel or reference signal, or a second channel type or reference signal type of the second uplink channel or reference signal; and performing a communication with a network node based at least in part on whether the first downlink channel or reference signal is permitted to overlap in time, in the full-duplex configuration, with the second uplink channel or reference signal.

Aspect 40: The method of Aspect 39, wherein identifying whether the first downlink channel or reference signal is permitted to overlap in time, in the full-duplex configuration, with the second uplink channel or reference signal further transmitting signaling indicating whether the first downlink channel or reference signal is permitted to overlap in time, in the full-duplex configuration, with the second uplink channel or reference signal.

Aspect 41: The method of any of Aspects 39-40, wherein identifying whether the first downlink channel or reference signal is permitted to overlap in time, in the full-duplex configuration, with the second uplink channel or reference signal is based at least in part on a preconfigured rule.

Aspect 42: The method of any of Aspects 39-41, wherein identifying whether the first downlink channel or reference signal is permitted to overlap in time, in the full-duplex configuration, with the second uplink channel or reference signal comprises identifying whether channels or signals of the first channel type or reference signal type are permitted to overlap in time with channels or signals of the second channel type or reference signal type.

Aspect 43: The method of any of Aspects 39-42, wherein identifying whether the first downlink channel or reference signal is permitted to overlap in time, in the full-duplex configuration, with the second uplink channel or reference signal is based at least in part on the first downlink channel or reference signal and the second uplink channel or reference signal being associated with a beam pair.

Aspect 44: The method of any of Aspects 39 or 41-43, wherein identifying whether the first downlink channel or reference signal is permitted to overlap in time, in the full-duplex configuration, with the second uplink channel or reference signal further comprises receiving an indication of whether the first downlink channel or reference signal is permitted to overlap in time, in the full-duplex configuration, with the second uplink channel or reference signal.

Aspect 45: The method of any of Aspects 39-44, wherein the first downlink channel or reference signal overlaps, in the full-duplex configuration, with the second uplink channel or reference signal at the network node based at least in part on the network node being a full-duplex network node.

Aspect 46: The method of any of Aspects 39-45, wherein the first downlink channel or reference signal overlaps, in the full-duplex configuration, with the second uplink channel or reference signal at the UE based at least in part on the UE being a full-duplex UE.

Aspect 47: The method of any of Aspects 39-46, wherein the first channel type or reference signal type comprises at least one of: a synchronization signal block (SSB) type, a physical downlink control channel (PDCCH) type, a physical downlink shared channel (PDSCH) type, a channel state information reference signal (CSI-RS) type, or a positioning reference signal (PRS) type.

Aspect 48: The method of Aspect 47, wherein the PDSCH type further comprises at least one of a dynamic grant PDSCH type or a semi-persistent scheduling PDSCH type.

Aspect 49: The method of Aspect 47, wherein the CSI-RS type further comprises at least one of: a periodic CSI-RS type, an aperiodic CSI-RS type, a semi-persistent CSI-RS type, a channel state feedback CSI-RS type, a beam management CSI-RS type, a tracking reference signal CSI-RS type, a radio resource management CSI-RS type, a beam failure detection CSI-RS type, a candidate beam detection CSI-RS type, a pathloss reference signal CSI-RS type, a Layer 1 measurement CSI-RS type, or a radio link monitoring CSI-RS type.

Aspect 50: The method of any of Aspects 39-46, wherein the second channel type or reference signal type comprises at least one of: a physical uplink control channel (PUCCH) type, a physical uplink shared channel (PUSCH) type, a physical random access channel (PRACH) type, a sounding reference signal (SRS) type, or an uplink positioning reference signal (PRS) type.

Aspect 51: The method of Aspect 50, wherein the PUSCH type further comprises at least one of a dynamic grant PUSCH type or a configured grant PUSCH type.

Aspect 52: The method of Aspect 50, wherein the PRACH type further comprises at least one of a dynamically scheduled PRACH type or a configured PRACH type.

Aspect 53: The method of Aspect 50, wherein the SRS type further comprises at least one of: a periodic SRS type, an aperiodic SRS type, a semi-persistent SRS type, a beam management SRS type, an antenna switching SRS type, a codebook-based uplink transmission SRS type, or a non-codebook-based uplink transmission SRS type.

Aspect 54: The method of any of Aspects 39-53, wherein identifying whether the first downlink channel or reference signal is permitted to overlap in time, in the full-duplex configuration, with the second uplink channel or reference signal is based at least in part on a use case of the first downlink channel or reference signal or on a use case the second uplink channel or reference signal.

Aspect 55: The method of Aspect 54, wherein the use case of the first downlink channel or reference signal or the use case the second uplink channel or reference signal: a subband full-duplex use case, a spatial-division-multiplexing-based partial overlapping or fully overlapping full-duplex use case, an intra-operator use case, an inter-operator use case, a legacy UE use case, a full duplex aware UE use case, a use case for a particular frequency range, band, or band combination, a full-duplex UE use case, or a full-duplex network node use case.

Aspect 56: The method of any of Aspects 39-55, wherein the full-duplex configuration comprises at least one of: a sub-band full-duplex configuration, a partially overlapped full-duplex configuration, or a fully overlapped full-duplex configuration.

Aspect 57: A method of wireless communication performed by a user equipment (UE), comprising: receiving an indication of a resource type of a resource; receiving a resource configuration for an uplink or downlink communication on the resource, wherein the resource configuration has a first link direction and the resource type of the resource indicates one of: a resource type for a second link direction different than the first link direction, or a flexible resource type; and performing a communication with a network node in accordance with a prioritization rule indicating whether the first link direction or the second link direction is to be used for the resource.

Aspect 58: The method of Aspect 57, wherein the resource type is indicated by a slot format indicator and comprises an uplink resource type or the flexible resource type, and the resource configuration is a configured channel state information reference signal configuration.

Aspect 59: The method of Aspect 57, wherein the resource type is indicated by a slot format indicator and comprises an uplink resource type or the flexible resource type, and the resource configuration is a configured semi-persistent scheduling configuration.

Aspect 60: The method of Aspect 57, wherein the resource type is indicated by a slot format indicator and comprises a downlink resource type or the flexible resource type, and the resource configuration is a configured control resource set configuration.

Aspect 61: The method of Aspect 57, wherein the resource type is indicated by a slot format indicator and comprises a downlink resource type or the flexible resource type, and the resource configuration is a configured physical uplink shared channel configuration.

Aspect 62: The method of Aspect 57, wherein the resource type is indicated by a slot format indicator and comprises an uplink resource type or the flexible resource type, and the resource configuration is a configured physical uplink control channel configuration.

Aspect 63: The method of Aspect 57, wherein the resource type is indicated by a slot format indicator and comprises an uplink resource type or the flexible resource type, and the resource configuration is a physical random access channel configuration.

Aspect 64: The method of Aspect 57, wherein the resource type is indicated by a radio resource control configuration and comprises the flexible resource type, and the resource configuration is a configured channel state information reference signal configuration.

Aspect 65: The method of Aspect 57, wherein the resource type is indicated by a radio resource control configuration and comprises the flexible resource type, and the resource configuration is a configured semi-persistent scheduling configuration.

Aspect 66: The method of Aspect 57, wherein the resource type is indicated by a radio resource control configuration and comprises the flexible resource type, and the resource configuration is a configured physical uplink shared channel configuration.

Aspect 67: The method of Aspect 57, wherein the resource type is indicated by a radio resource control configuration and comprises the flexible resource type, and the resource configuration is a configured physical uplink control channel configuration.

Aspect 68: The method of Aspect 57, wherein the resource type is indicated by a radio resource control configuration and comprises the flexible resource type, and the resource configuration is a physical random access channel configuration.

Aspect 69: The method of Aspect 57, wherein the resource type is indicated by a slot format indicator and comprises a downlink resource type or the flexible resource type, wherein performing the communication in accordance with the prioritization rule further comprises: transmitting an uplink transmission in the first link direction based at least in part on the uplink transmission being associated with a threshold priority; and dropping a downlink reception in the second link direction.

Aspect 70: The method of Aspect 57, wherein the resource type is indicated by a slot format indicator and comprises a downlink resource type or the flexible resource type, wherein performing the communication in accordance with the prioritization rule further comprises: receiving a downlink transmission in the second link direction on the resource.

Aspect 71: The method of Aspect 57, wherein the resource type is indicated by a radio resource control configuration and comprises the flexible resource type, wherein performing the communication in accordance with the prioritization rule further comprises: transmitting an uplink transmission in the first link direction based at least in part on the uplink transmission being associated with a threshold priority; and dropping a downlink reception in the second link direction.

Aspect 72: The method of Aspect 57, wherein the resource type is indicated by a radio resource control configuration and comprises the flexible resource type, wherein performing the communication in accordance with the prioritization rule further comprises: receiving a downlink transmission in the second link direction on the resource.

Aspect 73: The method of Aspect 57, wherein the resource type is indicated by a slot format indicator and comprises an uplink resource type or the flexible resource type, wherein performing the communication in accordance with the prioritization rule further comprises: receiving a downlink transmission in the first link direction based at least in part on the downlink transmission being associated with a threshold priority; and dropping an uplink transmission in the second link direction.

Aspect 74: The method of Aspect 57, wherein the resource type is indicated by a slot format indicator and comprises a downlink resource type or the flexible resource type, wherein performing the communication in accordance with the prioritization rule further comprises: transmitting an uplink transmission in the second link direction on the resource.

Aspect 75: The method of Aspect 57, wherein the resource type is indicated by a radio resource control configuration and comprises the flexible resource type, wherein performing the communication with the UE in accordance with the prioritization rule further comprises: receiving a downlink transmission in the first link direction based at least in part on the downlink transmission being associated with a threshold priority; and dropping an uplink transmission in the second link direction.

Aspect 76: The method of Aspect 57, wherein the resource type is indicated by a radio resource control configuration and comprises the flexible resource type, wherein performing the communication with the UE in accordance with the prioritization rule further comprises: transmitting an uplink transmission in the second link direction on the resource.

Aspect 77: An apparatus for wireless communication at a device, comprising a processor; memory coupled with the processor; and instructions stored in the memory and executable by the processor to cause the apparatus to perform the method of one or more of Aspects 1-76.

Aspect 78: A device for wireless communication, comprising a memory and one or more processors coupled to the memory, the one or more processors configured to perform the method of one or more of Aspects 1-76.

Aspect 79: An apparatus for wireless communication, comprising at least one means for performing the method of one or more of Aspects 1-76.

Aspect 80: A non-transitory computer-readable medium storing code for wireless communication, the code comprising instructions executable by a processor to perform the method of one or more of Aspects 1-76.

Aspect 81: A non-transitory computer-readable medium storing a set of instructions for wireless communication, the set of instructions comprising one or more instructions that, when executed by one or more processors of a device, cause the device to perform the method of one or more of Aspects 1-76.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A network node for wireless communication, comprising:
a memory; and
one or more processors, coupled to the memory, configured to:
identify whether a first downlink channel or reference signal is permitted to overlap in time, in a full-duplex configuration, with a second uplink channel or reference signal based at least in part on:
a first channel type or reference signal type of the first downlink channel or reference signal, or
a second channel type or reference signal type of the second uplink channel or reference signal; and
schedule a communication of a user equipment (UE) based at least in part on whether the first downlink channel or reference signal is permitted to overlap in time, in the full-duplex configuration, with the second uplink channel or reference signal.

2. The network node of claim 1, wherein the one or more processors, to identify whether the first downlink channel or reference signal is permitted to overlap in time, in the full-duplex configuration, with the second uplink channel or reference signal, are configured to receive, from the UE, signaling indicating whether the first downlink channel or reference signal is permitted to overlap in time, in the full-duplex configuration, with the second uplink channel or reference signal.

3. The network node of claim 1, wherein identifying whether the first downlink channel or reference signal is permitted to overlap in time, in the full-duplex configuration, with the second uplink channel or reference signal is based at least in part on a preconfigured rule.

4. The network node of claim 1, wherein the one or more processors, to identify whether the first downlink channel or reference signal is permitted to overlap in time, in the full-duplex configuration, with the second uplink channel or reference signal, are configured to identify whether channels or signals of the first channel type or reference signal type are permitted to overlap in time with channels or signals of the second channel type or reference signal type.

5. The network node of claim 1, wherein identifying whether the first downlink channel or reference signal is permitted to overlap in time, in the full-duplex configuration, with the second uplink channel or reference signal is based at least in part on the first downlink channel or reference signal and the second uplink channel or reference signal being associated with a beam pair.

6. The network node of claim 1, wherein the one or more processors, to identify whether the first downlink channel or reference signal is permitted to overlap in time, in the full-duplex configuration, with the second uplink channel or reference signal, are configured to transmit an indication of whether the first downlink channel or reference signal is permitted to overlap in time, in the full-duplex configuration, with the second uplink channel or reference signal.

7. The network node of claim 1, wherein the first downlink channel or reference signal overlaps, in the full-duplex configuration, with the second uplink channel or reference signal at the network node based at least in part on the network node being a full-duplex network node.

8. The network node of claim 1, wherein the first downlink channel or reference signal overlaps, in the full-duplex configuration, with the second uplink channel or reference signal at the UE based at least in part on the UE being a full-duplex UE.

9. The network node of claim 1, wherein the first channel type or reference signal type comprises at least one of:
a synchronization signal block (SSB) type,
a physical downlink control channel (PDCCH) type,
a physical downlink shared channel (PDSCH) type,
a channel state information reference signal (CSI-RS) type, or
a positioning reference signal (PRS) type.

10. The network node of claim 1, wherein the second channel type or reference signal type comprises at least one of:
a physical uplink control channel (PUCCH) type,
a physical uplink shared channel (PUSCH) type,
a physical random access channel (PRACH) type,
a sounding reference signal (SRS) type, or
an uplink positioning reference signal (PRS) type.

11. The network node of claim 1, wherein identifying whether the first downlink channel or reference signal is permitted to overlap in time, in the full-duplex configuration, with the second uplink channel or reference signal is based at least in part on a use case of the first downlink channel or reference signal or on a use case the second uplink channel or reference signal.

12. The network node of claim 1, wherein the full-duplex configuration comprises at least one of:
a sub-band full-duplex configuration,
a partially overlapped full-duplex configuration, or
a fully overlapped full-duplex configuration.

13. A network node for wireless communication, comprising:
a memory; and
one or more processors, coupled to the memory, configured to:
output an indication of a resource type of a resource;
output a resource configuration for an uplink or downlink communication on the resource, wherein the resource configuration has a first link direction and the resource type of the resource indicates one of a resource type for a second link direction different than the first link direction, or a flexible resource type; and
perform a communication with a user equipment (UE) in accordance with a prioritization rule indicating whether the first link direction or the second link direction is to be used for the resource.

14. The network node of claim 13, wherein the resource type is indicated by a slot format indicator and comprises an uplink resource type or the flexible resource type, and the resource configuration is a configured channel state information reference signal configuration.

15. The network node of claim 13, wherein the resource type is indicated by a slot format indicator and comprises an uplink resource type or the flexible resource type, and the resource configuration is a configured semi-persistent scheduling configuration.

16. The network node of claim 13, wherein the resource type is indicated by a slot format indicator and comprises a downlink resource type or the flexible resource type, and the resource configuration is a configured control resource set configuration.

17. The network node of claim 13, wherein the resource type is indicated by a slot format indicator and comprises a downlink resource type or the flexible resource type, and the resource configuration is a configured physical uplink shared channel configuration.

18. The network node of claim 13, wherein the resource type is indicated by a slot format indicator and comprises a downlink resource type or the flexible resource type, and the resource configuration is a configured physical uplink control channel configuration.

19. The network node of claim 13, wherein the resource type is indicated by a slot format indicator and comprises a downlink resource type or the flexible resource type, and the resource configuration is a physical random access channel configuration.

20. The network node of claim 13, wherein the resource type is indicated by a radio resource control configuration and comprises the flexible resource type, and the resource configuration is a configured channel state information reference signal configuration.

21. The network node of claim 13, wherein the resource type is indicated by a radio resource control configuration and comprises the flexible resource type, and the resource configuration is a configured semi-persistent scheduling configuration.

22. The network node of claim 13, wherein the resource type is indicated by a radio resource control configuration and comprises the flexible resource type, and the resource configuration is a configured physical uplink shared channel configuration.

23. The network node of claim 13, wherein the resource type is indicated by a radio resource control configuration and comprises the flexible resource type, and the resource configuration is a configured physical uplink control channel configuration.

24. The network node of claim 13, wherein the resource type is indicated by a radio resource control configuration and comprises the flexible resource type, and the resource configuration is a physical random access channel configuration.

25. The network node of claim 13, wherein the resource type is indicated by a slot format indicator and comprises a downlink resource type or the flexible resource type, wherein performing the communication with the UE in accordance with the prioritization rule further comprises:
obtain an uplink transmission in the first link direction based at least in part on the uplink transmission being associated with a threshold priority.

26. The network node of claim 13, wherein the resource type is indicated by a radio resource control configuration and comprises the flexible resource type, wherein performing the communication with the UE in accordance with the prioritization rule further comprises:
obtain an uplink transmission in the first link direction based at least in part on the uplink transmission being associated with a threshold priority.

27. A user equipment (UE) for wireless communication, comprising:
a memory; and
one or more processors, coupled to the memory, configured to:
identify whether a first downlink channel or reference signal is permitted to overlap in time, in a full-duplex configuration, with a second uplink channel or reference signal based at least in part on:
a first channel type or reference signal type of the first downlink channel or reference signal, or
a second channel type or reference signal type of the second uplink channel or reference signal; and
perform a communication with a network node based at least in part on whether the first downlink channel or reference signal is permitted to overlap in time, in the full-duplex configuration, with the second uplink channel or reference signal.

28. The UE of claim 27, wherein identifying whether the first downlink channel or reference signal is permitted to overlap in time, in the full-duplex configuration, with the second uplink channel or reference signal further transmitting signaling indicating whether the first downlink channel or reference signal is permitted to overlap in time, in the full-duplex configuration, with the second uplink channel or reference signal.

29. A user equipment (UE) for wireless communication, comprising:
a memory; and
one or more processors, coupled to the memory, configured to:
receive an indication of a resource type of a resource;
receive a resource configuration for an uplink or downlink communication on the resource, wherein the resource configuration has a first link direction and the resource type of the resource indicates one of a resource type for a second link direction different than the first link direction, or a flexible resource type; and
perform a communication with a network node in accordance with a prioritization rule indicating whether the first link direction or the second link direction is to be used for the resource.

30. The UE of claim 29, wherein the resource type is indicated by a slot format indicator and comprises an uplink resource type or the flexible resource type, and the resource configuration is a configured channel state information reference signal configuration.
